(19) United States
(12) Patent Application Publication
(10) Pub. No.: US 2025/0267680 A1
(43) Pub. Date: Aug. 21, 2025

(54) METHOD FOR RECEIVING DOWNLINK CONTROL INFORMATION, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi ZHANG, Dongguan (CN); Yanan LIN, Dongguan (CN)

(21) Appl. No.: 19/204,368

(22) Filed: May 9, 2025

Related U.S. Application Data
(63) Continuation of application No. PCT/CN2023/073258, filed on Jan. 19, 2023.

(51) Int. Cl. H04W 72/232; H04W 72/0453

(52) U.S. Cl. CPC H04W 72/232; H04W 72/0453

(57) ABSTRACT

Provided is a method for receiving downlink control information (DCI). The method is applicable to a terminal device, and includes: receiving first DCI, wherein the first DCI is used to schedule N data channels and includes a frequency domain resource assignment (FDRA) indication field, wherein the FDRA indication field indicates frequency domain resource information corresponding to the N data channels, and N is a positive integer.

### CROSS-REFERENCE TO RELATED APPLICATION

This application is a continuation of International Application No. PCT/CN2023/073258, filed Jan. 19, 2023, the entire disclosure of which is incorporated herein by reference.

### TECHNICAL FIELD

Embodiments of the present disclosure relates to the technical field of communications, and in particular, relate to a method for receiving downlink control information, a terminal device, and a network device.

### RELATED ART

In an ultra-reliable and low-latency communication (URLLC) project standardization process, a piece of downlink control information (DCI) schedules data channels corresponding to a plurality of cells.

### SUMMARY

Embodiments of the present disclosure provide a method for receiving downlink control information, a terminal device, and a network device. The technical solutions are as follows.

According to some embodiments of the present disclosure, a method for receiving downlink control information is provided. The method is applicable to a terminal device, and includes:
receiving first DCI, wherein the first DCI is used to schedule N data channels, and includes a frequency domain resource assignment (FDRA) indication field, wherein the FDRA indication field indicates frequency domain resource information corresponding to the N data channels, and N is a positive integer.

According to some embodiments of the present disclosure, a terminal device is provided. The terminal includes: a processor, a transceiver connected to the processor, and a memory storing one or more executable instructions of the processor; wherein the transceiver is configured to load and execute the one or more executable instructions to cause the network device to receive first DCI, wherein the first DCI is used to schedule N data channels and comprises an FDRA indication field, wherein the FDRA indication field indicates frequency domain resource information corresponding to the N data channels, and N is a positive integer.

According to some embodiments of the present disclosure, a network device is provided. The network device includes: a processor, a transceiver connected to the processor, and a memory storing one or more executable instructions of the processor; wherein the transceiver is configured to load and execute the one or more executable instructions to cause the network device to transmit first DCI, wherein the first DCI is used to schedule N data channels, and comprises an FDRA indication field, wherein the FDRA indication field indicates frequency domain resource information corresponding to the N data channels, and N is a positive integer.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings for the following description show merely some embodiments of the present disclosure, and persons of ordinary skill in the art may still derive other drawings from these accompanying drawings without creative efforts.

FIG. 1 is a schematic scenario diagram of a communication system according to some embodiments of the present disclosure;

FIG. 2 is a schematic diagram of Type 0 FDRA in some practices;

FIG. 3 is a schematic diagram of Type 1 FDRA in some practices;

FIG. 4 is a flowchart of a method for receiving downlink control information according to some embodiments of the present disclosure;

FIG. 5 is a flowchart of a method for receiving downlink control information according to some embodiments of the present disclosure;

FIG. 6 is a flowchart of a method for receiving downlink control information according to some embodiments of the present disclosure;

FIG. 7 is a flowchart of a method for receiving downlink control information according to some embodiments of the present disclosure;

FIG. 8 is a flowchart of a method for receiving downlink control information according to some embodiments of the present disclosure;

FIG. 9 is a flowchart of a method for receiving downlink control information according to some embodiments of the present disclosure;

FIG. 10 is a flowchart of a method for receiving downlink control information according to some embodiments of the present disclosure;

FIG. 11 is a flowchart of a method for receiving downlink control information according to some embodiments of the present disclosure;

FIG. 12 is a flowchart of a method for receiving downlink control information according to some embodiments of the present disclosure;

FIG. 13 is a flowchart of a method for transmitting downlink control information according to some embodiments of the present disclosure;

FIG. 14 is a flowchart of a method for transmitting downlink control information according to some embodiments of the present disclosure;

FIG. 15 is a flowchart of a method for transmitting downlink control information according to some embodiments of the present disclosure;

FIG. 16 is a block diagram of an apparatus for receiving downlink control information according to some embodiments of the present disclosure;

FIG. 17 is a block diagram of an apparatus for transmitting downlink control information according to some embodiments of the present disclosure; and

FIG. 18 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

Embodiments are illustratively described herein and are illustrated in the accompanying drawings. Unless otherwise indicated, the same number in different accompanying drawings indicates the same or similar elements in following descriptions of the accompanying drawings. The following exemplary embodiments do not represent all embodiments consistent with the present disclosure, and are merely examples of devices and methods that are consistent with aspects of the present disclosure as detailed in the appended claims.

The terms used in the present disclosure are for describing specific embodiments and are not intended to limit the present disclosure. The terms “a,” “an,” and “the” in the singular form used in the present disclosure and the appended claims are also intended to include the plural form, unless clearly indicates in the context otherwise. It should be further understood that the term “and/or” herein refers to and includes any or all possible combinations of one or more associated and listed items.

It should be noted that user information (including but not limited to user equipment information, user personal information, and the like) and data (including but not limited to data for analysis, stored data, displayed data, and the like) in the present disclosure are information and data authorized by the users or fully authorized by the parties. The collection, use, and processing of relevant data shall comply with the relevant laws, regulations, and standards of the relevant countries and regions.

It should be understood that although the terms “first,” “second,” and the like may be used herein to describe various pieces of information in the present disclosure, such information should not be limited to these terms. These terms are only used to distinguish one type of information from another. For example, a first parameter may also be referred to as a second parameter, and similarly, a second parameter is also referred to as a first parameter, without departing from the scope of the present disclosure. The word “if,” as used herein, may be interpreted as “in a case where,” “in a case that,” “in the case that,” “in the case of,” or “in response to determining that,” depending on the context.

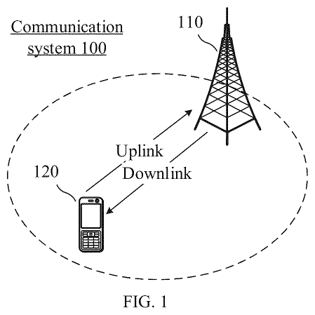

FIG. 1 is a schematic scenario diagram of a communication system 100 according to some embodiments of the present disclosure. The communication system 100 includes a network device 110 and a terminal device 120.

The network device 110 according to the present disclosure provide a wireless communication function. The network device 110 includes, but is not limited to, an evolved node B (eNB), a radio network controller (RNC), a node B (NB), a base station controller (BSC), a base transceiver station (BTS), a home station (for example, a home evolved node B or a home node B (HNB)), a base band unit (BBU), an access point (AP) in a wireless fidelity (Wi-Fi) system, a wireless relay node, a wireless return node, a transmission point (TP), a transmission and reception point (TRP), a next generation node B (gNB), TRP or TP in a 5G system, one or a set of antenna panels (including a plurality of antenna panels) for a base station in a 5G system, or a network node that constitutes a gNB or a TP (such as a baseband unit (BBU) or a distributed unit (DU)), a base station in a 6G communication system, a core network (CN), a fronthaul, a backhaul, a radio access network (RAN), a network slicing, or a service cell, a primary cell (Pcell), a primary secondary cell (PSCell), a special cell (SpCell), a secondary cell (Scell), a neighborhood cell of the terminal device, or the like.

The terminal device 120 according to the present disclosure is referred to as a user equipment (UE), an access terminal, a subscriber unit, a subscriber station, a mobile station, a mobile console, a remote station, a remote terminal, a mobile device, a subscriber terminal, a terminal, a wireless communication device, a user agent, a user device, or the like. The terminal includes, but is not limited to, handheld devices, wearable devices, in-vehicle devices, IoT devices, and the like, such as a mobile phone, a tablet, an e-reader, a laptop, a desktop computer, a television, a game console, a mobile Internet device (MID), an augmented reality (AR) terminal, a virtual reality (VR) terminal, a mixed reality (MR) terminal, a wearable device, a hand shank, an electronic tag, a controller, a wireless terminal in the context of industry control, a wireless terminal in the context of self-driving, a wireless terminal in the context of remote medical, a wireless terminal in the context of smart gride, a wireless terminal in the context of transportation safety, a wireless terminal in the context of smart city, a wireless terminal in the context of smart home, a wireless terminal in the context of remove medical surgery, a cellular phone, a cordless phone, a session initiation protocol (SIP) phone, a wireless local loop (WLL) station, a personal digital assistant (PDA), a TV set-top box (STB), a customer premise equipment (CPE), and the like.

The network device 110 is in communication with the terminal device 120 over an air interface technology, for example, over a Uu interface.

Illustratively, communications between the network device 110 and the terminal device 120 includes two communication scenarios, that is, an uplink communication scenario and a downlink communication scenario. Signals are transmitted to the network device 110 in the uplink communication scenario, and signals are transmitted to the terminal device 120 in the downlink communication scenario.

The technical solutions according to the embodiments of the present disclosure are applicable to various communication systems, such as a global system of mobile communication (GSM), a code-division multiple access (CDMA) system, a wideband code-division multiple access (WCDMA) system, a general packet radio service (GPRS) system, a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a wireless local area network (WLAN), a wireless fidelity (Wi-Fi), a cellular IoT system, a cellular passive IoT system, evolution systems of the 5G NR system, and evolution systems of the 6G NR system. In some embodiments of the present disclosure, the “NR” is also referred to as a 5G NR system or a 5G system. The 5G mobile communication system includes a non-standalone (NSA) network and/or a stand alone (SA) network.

The technical solutions according to the embodiments of the present disclosure are also applicable to machine-type communications (MTC), a long-term evolution-machine (LTE-M) technology, a device-to-device (D2D) network, a machine-to-machine (M2M) network, an IoT network, or other networks. The IoT network includes, for example, Internet of vehicles. Communication modes in the Internet of vehicles system are collectively referred to as vehicle-to-X (V2X, X represents anything). For example, the V2X includes (vehicle-to-vehicle (V2V) communications, vehicle-to-infrastructure (V2I) communications, vehicle-to-pedestrian (V2P) or vehicle-to-network (V2N) communications, and the like.

The communication system according to the embodiments of the present disclosure is applicable to communication scenarios, including, but not limited to at least one of an uplink communication scenario, a downlink communication scenario, or a sidelink communication scenario.

Relevant technologies involved in the embodiments of the present disclosure are described.

### NR FDRA

Both NR uplink/downlink support two FDRA types, that is, type 0 FDRA and type 1 FDRA. A network device configures an FDRA type used by a terminal device based on a high layer parameter resourceAllocation, and the high layer parameter resourceAllocation configures the terminal device to use the type 0 FDRA, the type 1 FDRA, or dynamic switch. In a case where a configuration parameter is the “dynamic switch,” the network device indicates the FDRA type used by the terminal device through an FDRA indication field in DCI. In the present disclosure, the FDRA indication field is an FDRA field for short.

The type 0 FDRA

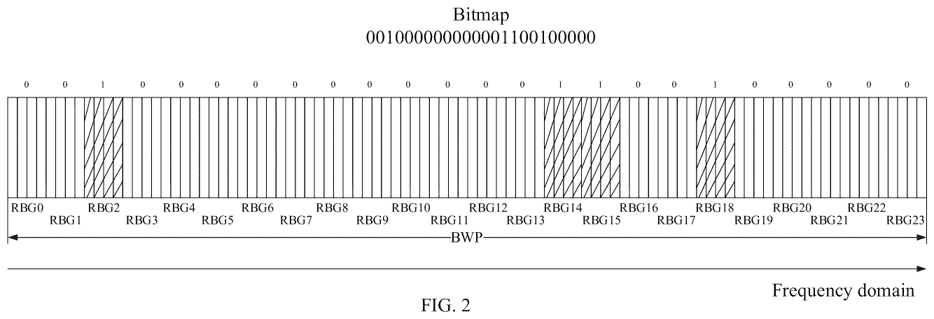

As shown in FIG. 2, a granularity of the type 0 FDRA is a resource block group (RBG), and the RBG is a combination of a series of contiguous virtual resource blocks (RBs). A number of virtual RBs in each RBG is determined based on a size of a bandwidth part (BWP) and a configuration parameter rbg-Size of radio resource control (RRC). The rbg-Size is used to configure “Configuration 1” or “Configuration 2” in Table 1.

TABLE 1
Correspondence relationship of RBG and bandwidth

| | |
|---|---|
| bandwidth of BWP (a | Size P of RBG (a number of RBs) |

| number of RBs) | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The type 0 FDRA indicates the RBG allocated to the terminal device using a bitmap. 1 indicates that the RBG is allocated to the terminal device, and 0 indicates that the RBG is not allocated to the terminal device, such that frequency domain resources are flexibly distributed in the BWP, incontiguous FDRA is supported, and discrete frequency domain transmission is used to combat frequency selective fading. But the disadvantages are as follows: (1) the bitmap has a large quantity of bits, and thus each RBG in the BWP needs to be covered; (2) the granularity of resource allocation is large because an RBG includes 2 to 16 RBs, and thus frequency domain resources are not allocated by RB.

For a BWP including N_{BWP}^{size} RBs, a number N_{RBG} of RBGs therein (from 0 to N_{RBG}-1) is:

$${N}_{RBG} = ⌈ ( {N}_{BWP , i}^{size} + ( {N}_{BWP , i}^{start} mod P ) ) / P ⌉ ;$$

N_{BWP,i}^{start} represents an index value of a common resource block (CRB) corresponding to a starting frequency domain location of the BWP, that is, a relative location of a starting location of the BWP and a lowest point of a carrier bandwidth frequency, P represents a size of a remaining RBG rather than a first RBG and a last RBG, mod is a modulo operator and represents a remainder acquired by dividing two numbers, and “[ ]” represents rounding upwards.

A size of the first RBG is:

$${RBG}_{0}^{size} = P - {N}_{BWP , i}^{start} mod P ;$$

In a case where (N_{BWP,i}^{start}+N_{BWP,i}^{size})modP>0, a size of the last RBG is:

$${RBG}_{last}^{size} = ( {N}_{BWP , i}^{start} + {N}_{BWP , i}^{size} ) mod P ;$$

Otherwise, in a case where (N_{BWP,i}^{start}+N_{BWP,i}^{size})modP≤0, the size of the last RBG is P.

### The Type 1 FDRA

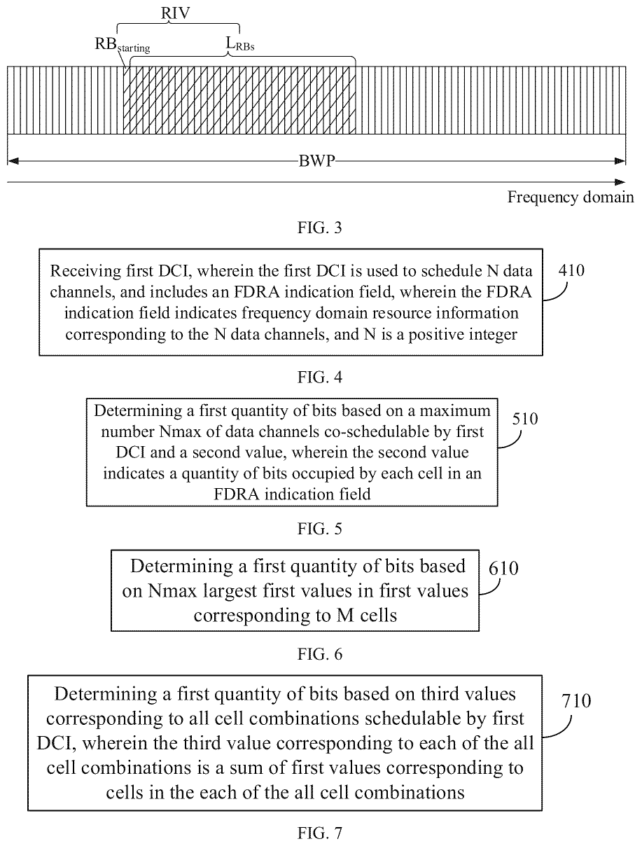

As shown in FIG. 3, the type 1 FDRA is indicated to a series of contiguous virtual RBs of the terminal, and a resource indication value (RIV) is used to jointly encode an assigned starting RB (RB_{starting}) and a number (L_{RBs}) of RBs jointly. The advantage of the type 1 is that RB-level frequency domain resources are indicated using a small quantity of bits, and the disadvantage is that only contiguous frequency domain resources are allocated, and in a case where a number of frequency domain resources is small, the frequency diversity is limited and is vulnerable to an effect of frequency selective fading. The joint coding method of the starting RB (RB starting) and the number (L_{RBs}) of RBs are as follows:
In a case where (L_{RBs}−1)≤N_{BWP}^{size}/2], RIV=N_{BWP}^{size}(L_{RBs}−1)+RBₛₜₐᵣₜ;
Otherwise, RIV=N_{BWP}^{size}(N_{BWP}^{size}(N_{BWP}^{size}−L_{RBs}+1)+(N_{BWP}^{size}−1−RBₛₜₐᵣₜ)
L_{RBs}≥1 and is not greater than N_{BWP}^{size}−RBₛₜₐᵣₜ. N_{BWP}^{size} represents the number of RBs in the BWP, and “└ ┘” represents rounding downwards.

In the URLLC project standardization process, compact DCI (including DCI format 0_2 or DCI format 1_2) is introduced to cause the physical downlink control channel (PDCCH) meet a reliability requirement of the URLLC. That is, the reliability of DCI transmission is improved by reducing the size of DCI. In the process of reducing the size of DCI, the frequency domain resource indication field is a crucial optimization direction. The URLLC mostly adopts large-bandwidth transmission, the indication granularity of the type 1 FDRA is 1 RB, and thus is fine for the large-bandwidth transmission. Therefore, the indication granularity of the type 1 FDRA is to-be-improved, and the overhead of the FDRA field is to-be-compressed. The details are as follows:

In a case where the DCI received by the terminal device is the DCI format 1_2 or the DCI format 0_2, the type 1 FDRA with the RB granularity is not adopted, and the type 1 FDRA with the RBG granularity is adopted. That is, an RIV is used to jointly encode the assigned starting RBG and the number of RBGs. A number of RBs in the granularity RBG of FDRA is configured by a high layer parameter “resource Allocation Type 1 GranularityDCI-1-2” or “resourceAllocationType 1 GranularityDCI-0-2”. The joint encoding method of the initial RBG and the number of RBGs is the same as the joint encoding method of the RB granularity, which is not repeated herein.
resourceAllocationType 1 GranularityDCI-1-2

Configure the scheduling granularity applicable for both the start point and length indication for resource allocation type 1 in DCI format 1_2. If this field is absent, the granularity is 1 PRB.
resourceAllocationType 1 GranularityDCI-0-2

Configure the scheduling granularity applicable for both the start point and length indication for resource allocation type 1 in DCI format 0_2. If this field is absent, the granularity is 1 PRB.

Using an example of DCI format 1_1 (supporting the type 0 FDRA and the type 1 FDRA with the RB granularity), a quantity of bits occupied by the FDRA indication field is determined by:
in a case where only the type 0 FDRA is configured, the FDRA indication field includes N_{RBG} bits, and N_{RBG} is a total number of RBGs in the BWPs in N_{BWP}^{size} RBs;
in a case where only the type 1 FDRA is configured, the FDRA indication field includes [log 2 (N_{RB}^{DL,BWP}(N_{RB}^{DL,BWP}+1)/2)] bits, and N_{RB}^{DL,BWP} is a bandwidth value of a downlink (DL) activation BWP; and
in a case where the type 0 FDRA and the type 1 FDRA are configured, the FDRA indication field includes max ([log₂ (N_{RB}^{DL,BWP}(N_{RB}^{DL,BWP}+1)/2)], N_{RBG})+1 bits. A most significant bit indicates a resource allocation type used by the terminal device, 0 represent the type 0, and 1 represents the type 1. N_{RBG} is a total number of RBGs in the BWPs in N_{RBS}^{size} RBs, and N_{RB}^{DL,BWP} is a bandwidth value of a DL activation BWP.

### Multi-Cell Scheduling

The current “multi-carrier” project supports that a DCI (for example, the DCI format 0_X or the DCI format 1_X) schedules physical downlink shared channels (PDSCHs) or physical uplink shared channels (PUSCHs) of a plurality of cells. The carrier and the cell are the same concept herein. A group of cells that can be scheduled by the DCI format 0_X or the DCI format 1_X schedules form a cell group, and a plurality of groups of cells that can be scheduled by the DCI format 0_X or the DCI format 1_X schedules form multiple cell groups. X represents a positive integer other than 1 and 2. It can be understood that a cell group is a unit (or a granularity) configured by the multi-carrier scheduling (that is, the multi-cell scheduling).

A cell group includes one or more cell combinations. The cell combination is formed by cells co-schedulable by the DCI format 0_X or the DCI format 1_X, and the cell combination is a subset or a complete set of a cell set.

Illustratively, the network device configures {cell 1, cell 2, cell 3, cell 4} as a first cell group, and the cell combination is a subset or a complete set of {cell 1, cell 2, cell 3, cell 4}. For example, in the first cell group, the cell combinations co-schedulable by the DCI format 0_X or the DCI format 1_X are shown in Table 2.

TABLE 2

| Index of cell | Co-scheduled cell/cell |
|---|---|
| combination | combination |
| 1 | cell 1 + cell 2 |
| 2 | cell 3 + cell 4 |
| 3 | cell 1 + cell 2 + cell 3 |
| 4 | cell 2 + cell 3 + cell 4 |
| 5 | cell 1 + cell 2 + cell 3 + cell 4 |

### DCI Field

For discussing field design of DCI format 0_X/1_X which schedules more than one cell, reformulate the types of DCI fields as below:

1.Type-1 field:
Type-1A field: A single field indicating common information to all the co-scheduled cells.
Type-1B field: A single field indicating separate information to each of co-scheduled cells via joint indication.
Type-1C field: A single field indicating an information to only one of co-scheduled cells.

The single field is a field concurrently indicating information of a plurality of data channels, a plurality of data transmissions, or a plurality of cells.

2.Type-2 field: A separate field for each of the co-scheduled cells.

The single field is a field corresponding to each of the plurality of data channels, each of the plurality of data transmissions, or each of the plurality of cells, and information of different data channel, different data transmissions, or different cells corresponds to different fields.

3.Type-3 field: Common or separate to each of the co-scheduled cells, or separate to each sub-set, dependent on explicit configuration.

Note: One sub-set includes a subset of co-scheduled cells where a single field is commonly applied to the co-scheduled cell(s) belonging to a same sub-set.

The allocation type of the FDRA indication field in the DCI format 0_X or the DCI format 1_X is the Type-2 field.

Type-2 field:
Further consider larger RBG granularity than existing maximum specified or configured value for RA Type0;
Use large RBG-based RIV for RA type 1 based on R16 configurable granularities for DCI format 1_2.

In some practices, a frequency domain resource assignment type is indicated by FDRA in the DCI.

However, how to determine frequency domain resource information corresponding to the data channel by the DCI is a problem to be solved.

FIG. 4 is a flowchart of a method for receiving DCI according to some embodiments of the present disclosure. The method is applicable to a terminal device, and includes the following processes.

In S410, first DCI is received, wherein the first DCI is used to schedule N data channels, and includes an FDRA indication field, wherein the FDRA indication field indicates frequency domain resource information corresponding to the N data channels, and N is a positive integer.

The FDRA indication field indicates the frequency domain resource information of the N scheduled data channels, or indicates the frequency domain resource information for the data channels corresponding to N cells in a scheduled first cell combination. The scheduled first cell combination is a combination of the N cells.

The first cell combination belongs to a first cell group. The N data channels are in one-to-one correspondence with the N cells. N is a positive integer. In some embodiments, N is equal to or greater than 1. In a case where N is greater than 1, the scheduling is also referred to as multi-cell co-scheduling.

In some embodiments, the FDRA indication field includes at least N FDRA sub-fields. The N FDRA sub-fields are in one-to-one correspondence with the N data channels, and an i^{th} FDRA indication sub-field indicates frequency domain resource information of an i^{th} data channel. i is an integer not greater than N.

In some embodiments, the FDRA indication field includes N bit sequences. The N bit sequences are in one-to-one correspondence with the N data channels, and an i^{th} bit sequence indicates frequency domain resource information of an i^{th} data channel. i is an integer not greater than N.

In some embodiments, the FDRA indication field includes one bit sequence. Part of bits in the bit sequences correspond to the N data channels. The part of bits are organized to N parts of bits, and the N parts of bits are in one-to-one correspondence with the N data channels.

In some embodiments, the N data channels are in at least one of the following cases.
The N data channels are all PDSCHs;
the N data channels are all PUSCHs; or
the N data channels include some PDSCHs and some PUSCHs.

In some embodiments, the N data channels further include sidelink data channels.

In some embodiments, the first cell group is pre-configured by the network device to the terminal device, or is predefined by the protocol. In some embodiments, an arrangement order of the cells in the first cell group is also pre-configured by the network device to the terminal device, or is predefined by the protocol.

In summary, in the method according to the embodiments, the first DCI is received, and is configured to schedule the N data channel. The first DCI includes the FDRA indication field, and the FDRA indication field indicates the frequency domain resource information corresponding to the N data channels. N is a positive integer. As such, the terminal device determines the frequency domain resource information corresponding to the N data channels by one piece of DCI.

In optional embodiments based on FIG. 4, a first quantity of bits occupied by the FDRA indication field is determined based on at least one of:
a maximum number Nmax of data channels co-schedulable by the first DCI, wherein Nmax is a maximum value of N; or
a first value corresponding to each cell in a first cell group, wherein the first value is a quantity of bits required for FDRA in a case where each cell is separately scheduled.

In some embodiments, the first quantity of bits is determined based on first values corresponding to the M cells in the first cell group. In some embodiments, the first quantity of bits is determined based on Nmax largest first values in the first values corresponding to the M cells in the first cell group. In some embodiments, the first quantity of bits is determined based on first values corresponding to the N cells in the first cell combination. In some embodiments, the first quantity of bits is determined based on N largest first values in the first values corresponding to the M cells in the first cell group. In some embodiments, the arrangement order of the cells in the cell combination is also pre-configured by the network device to the terminal device, or is predefined by the protocol.

The N data channels are in one-to-one correspondence with the N cells, the N cells are a subset or a complete set of the first cell group, and the first cell group is a set of the M cells. M is greater than or equal to N, and N is a positive integer. The data channels co-schedulable by the first DCI mean the data channels that the first DCI allows to co-schedule, or the data channels that the first DCI can co-schedule, the data channels that the DCI format of the first DCI supports in co-scheduling, or the data channels that the DCI format of the first DCI allows to co-schedule.

In a specific scheduling process, a number of data channels actually scheduled by the first DCI is less than or equal to the maximum number Nmax.

Illustratively, assuming that the first cell is any cell in the M cells in the first cell group, then the first value of the first cell is determined based on at least one of:
1. a size of the activation BWP of the first cell, for example, the activation BWP includes a first number of RBs;
2. an FDRA type corresponding to the first cell, for example, the FDRA type 0 or the FDRA type 1;
3. a first FDRA granularity corresponding to the first cell, for example, the RBG includes a second number of RBs; or
4. a frequency-hopping related parameter corresponding to the first cell, for example, a frequency hopping offset list parameter frequencyHoppingOffsetLists.

Illustratively, in a case where the hopping frequency is configured for the terminal device, the FDRA indication field needs to indicate a frequency offset. The indication mode of the frequency offset including configuring two or four candidate offset values by the RRC parameter frequencyHoppingOffsetLists. In a case where two candidate offset values are configured, hopping frequency indication information in the FDRA indication field needs 1 bit; and in a case where four candidate offset values are configured, hopping frequency indication information in the FDRA indication field needs 2 bits. The frequency hopping offset is used to determine an offset value of a frequency domain resource before and after frequency hopping. That is, the hopping frequency indication information is determined based on a number of candidate offset values.

In summary, in the method according to the present disclosure, the first DCI is received, and is configured to schedule the N data channel. The first DCI includes the FDRA indication field, and the FDRA indication field indicates the frequency domain resource information corresponding to the N data channels. N is a positive integer. As such, the terminal device determines the frequency domain resource information corresponding to the N data channels by one piece of DCI.

### A First Method for Determining the First Quantity of Bits Occupied by the FDRA Indication Field

FIG. 5 is a flowchart of a method for receiving DCI according to some embodiments of the present disclosure. The method is applicable to a terminal device, and includes the following processes.

In S510, a first quantity of bits is determined based on a maximum number Nmax of data channels co-schedulable by first DCI and a second value, wherein the second value indicates a quantity of bits occupied by each cell in an FDRA indication field.

The first quantity of bits is determined based on the maximum number Nmax of data channels co-schedulable by first DCI and the second value, and the data channels co-schedulable by the first DCI mean the data channel that the first DCI allows to co-schedule or the data channel that the first DCI can co-schedule.

The second value is determined based on the first value corresponding to each of the at least one cell, is predefined by a communication protocol, or is configured by the network device.

In some embodiments, the first quantity of bits is a product of the maximum number Nmax of data channels co-schedulable by the first DCI and the second value.

In some embodiments, the second value includes at least one of:
a maximum value in M first values corresponding to M cells;
a minimum value in M first values corresponding to M cells;
an average value of M first values corresponding to M cells;
a median value of M first values corresponding to M cells;
a first value corresponding to a cell with a largest cell index in M cells; or
a first value corresponding to a cell with a smallest cell index in M cells;

A first cell group is a set of the M cells, N cells are in one-to-one correspondence with the N data channels, and the N cells are a subset or a complete set of the first cell group. M is greater than or equal to N.

In some embodiments, the second value is determined based on a first value corresponding to a second cell. The second cell is configured by the network device or predefined by the communication protocol.

In some embodiments, the second value is predefined by the communication protocol or is configured by the network device, and is greater than or equal to a maximum value in the first values corresponding to each cell in the M cells.

In some examples, the network device configures {cell 1, cell 2, cell 3, and cell 4} to the terminal device as the first cell group. For the first cell group, the cell combination scheduled by the first DCI is a subset or a complete set of {cell 1, cell 2, cell 3, cell 4}. Using an example where N is greater than 1, the co-scheduled cell combinations in the first cell group are shown in Table 3 (only part not all of the cell combinations are illustratively shown).

TABLE 3

| Index of cell | Co-scheduled cell/cell |
|---|---|
| combination | combination |
| 1 | cell 1 + cell 2 |
| 2 | cell 3 + cell 4 |
| 3 | cell 1 + cell 3 |
| 4 | cell 1 + cell 2 + cell 3 |

The DCI format for scheduling the cell combinations is the DCI format 0_X or the DCI format 1_X, the DCI format 0_X is used to schedule the PUSCH, and the DCI format 1_X is used to schedule the PDSCH. In one example, a maximum number of data channels co-schedulable by the DCI format 0_X is 3, and the maximum number of data channels co-schedulable by the DCI format 1_X is 3.

Based on the size of the activation BWP, the frequency domain resource type, and the first FDRA granularity configured in the cell 1, the cell 2, the cell 3, and the cell 4, the quantities of bits required for FDRA in separately scheduling the cell 1, the cell 2, the cell 3, and the cell 4 are determined as the first values. The calculation method of the first value is as follows.

In a case where the FDRA type 0 is configured, the required a quantity of bits is N_{RBG} bits, and N_{RBG} is a total number of RBGs in the BWPs in N_{BWP}^{size} RBs;

In a case where the FDRA type 1 is configured, the required quantity of bits is [log₂(N_{RB}^{DL,BWP}(N_{RB}^{DL,BWP}+1)/2)] bits, and N_{RB}^{DL,BWP} is the size of the DL activation BWP; and

In a case where the FDRA type 0 and the FDRA type 1 are configured, the FDRA indication field includes max (log₂(N_{RB}^{DL,BWP}(N_{RB}^{DL,BWP}+1)/2)], N_{RBG})+1 bits. A most significant bit indicates a resource allocation type used by the terminal device, 0 represent the type 0, and 1 represents the type 1. N_{RBG} is a total number of RBGs in the BWPs in N_{BWP}^{size} is RBs, and N_{RB}^{DL,BWP} the size of the DL activation BWP.

Illustratively, the embodiments are illustrated using an example where the required quantities of bits in separately scheduling the cell 1, the cell 2, the cell 3, and the cell 4 are 6, 6, 7, and 8.

In a case where the second value is the maximum value (that is, 8 bits) in M first values corresponding to M cells, the first quantity of bits is 8*3, that is, 24 bits.

In a case where the second value is the minimum (that is, 6 bits) in M first values corresponding to M cells, the first quantity of bits is 6*3, that is, 18 bits.

In a case where the second value is the first value (that is, 8 bits) corresponding to the cell with the largest cell index in M cells, the first quantity of bits is 8*3, that is, 24 bits.

In a case where the second value is the first value (that is, 6 bits) corresponding to the cell with the smallest cell index in M cells, the first quantity of bits is 6*3, that is, 18 bits.

In summary, in the method according to the present disclosure, the first quantity of bits is determined based on the maximum number Nmax of data channels co-schedulable by the first DCI and the second value. As the maximum number Nmax and/or the second value are configured based on semi-static configuration information, the terminal device determines the first quantity of bits based on the semi-static configuration information, which is simple and easy.

### A Second Method for Determining the First Quantity of Bits Occupied by the FDRA Indication Field

FIG. 6 is a flowchart of a method for receiving DCI according to some embodiments of the present disclosure. The method is applicable to a terminal device, and includes the following processes.

In S610, a first quantity of bits is determined based on Nmax largest first values in first values corresponding to M cells.

The first cell group is a set of M cells, and the first quantity of bits is determined based on the Nmax largest first values in the first values corresponding to the M cells. Nmax is a largest number of data channels co-schedulable by the first DCI, M is an integer greater than or equal to N. The Nmax largest first values are first Nmax first values in a descending order in the first values corresponding to the M cells.

For example, in a case where Nmax is 3, the required quantities of bits in separately scheduling the cell 1, the cell 2, the cell 3, and the cell 4 are 6, 7, 7, and 7, the three largest first values are 7, 7, and 7.

Alternatively, in a case where Nmax is 3, the required quantities of bits in separately scheduling the cell 1, the cell 2, the cell 3, and the cell 4 are 5, 6, 7, and 8, the three largest first values are 6, 7, and 8.

The data channels co-schedulable by the first DCI mean the data channels that the first DCI allows to co-schedule, or the data channels that the first DCI can co-schedule, or the data channels that the DCI format of the first DCI supports in co-scheduling, or the data channels that the DCI format of the first DCI allows to co-schedule.

In some embodiments, the first quantity of bits is a sum of the Nmax largest first values in the first values corresponding to the M cells.

In some illustrative example, the network device configures {cell 1, cell 2, cell 3, and cell 4} as the first cell group. For the first cell group, the cell combination scheduled by the first DCI is a subset or a complete set of {cell 1, cell 2, cell 3, cell 4}. The co-scheduled cell combinations in the first cell group are shown in Table 3.

The DCI format for scheduling the cell combinations is the DCI format 0_X or the DCI format 1_X, the DCI format 0_X is used to schedule the PUSCH, and the DCI format 1_X is used to schedule the PDSCH. In one example, a maximum number of data channels co-schedulable by the DCI format 0_X is 3, and the maximum number of data channels co-schedulable by the DCI format 1_X is 3.

The method for calculating the required quantities of bits in separately scheduling the cell 1, the cell 2, the cell 3, and the cell 4, that is, the first values, is described above, which is not repeated herein. Illustratively, the embodiments are illustrated using an example where the required quantities of bits in separately scheduling the cell 1, the cell 2, the cell 3, and the cell 4 are 6, 6, 7, and 8.

In 6, 6, 7, and 8, three largest first values are 8, 7, and 6, and thus the first value is 8+7+6, that is, 21 bits.

In summary, in the method according to the present disclosure, the first quantity of bits is determined based on the Nmax largest first values in the first values corresponding to the M cells. Compared with the first determining method, the determined quantity of bits occupied by the FDRA indication field is less, such that the communication resource required for the first DCI is saved, and the parsing speed of the first DCI is improved.

### A Third Method for Determining the First Quantity of Bits Occupied by the FDRA Indication Field

FIG. 7 is a flowchart of a method for receiving DCI according to some embodiments of the present disclosure. The method is applicable to a terminal device, and includes the following processes.

In S710, a first quantity of bits is determined based on third values corresponding to all cell combinations scheduled by first DCI, wherein the third value corresponding to each of the all cell combinations is a sum of first values corresponding to cells in the each of the all cell combinations.

The first quantity of bits is determined based on the third values corresponding to all cell combinations scheduled by the first DCI. The third value corresponding to each of the all cell combinations is the sum of the first values corresponding to the cells in the each of the all cell combinations, and the all cell combinations belong to the first cell group.

All cell combinations scheduled by the first DCI mean all cell combinations that the first DCI allows to schedule, or all cell combinations that the first DCI can schedule, or all cell combinations that the DCI format of the first DCI supports in co-scheduling, or all cell combinations that the DCI format of the first DCI allows to co-schedule. In one scheduling process, the first DCI only schedules one cell combination, that is, the first cell combination. The first cell combination is a combination of N cells, and the N cells are in one-to-one correspondence with the N data channels.

In some embodiments, the first quantity of bits is a maximum value in the third values corresponding to the all cell combinations scheduled by the first DCI. In some embodiments, the first quantity of bits is a minimum value in the third values corresponding to the all cell combinations scheduled by the first DCI. In some embodiments, the first quantity of bits is an average value of the third values corresponding to the all cell combinations scheduled by the first DCI. In some embodiments, the first quantity of bits is a third value corresponding to the first cell combination currently scheduled by the first DCI.

In some examples, the network device configures {cell 1, cell 2, cell 3, and cell 4} as the first cell group. For the first cell group, the cell combination scheduled by the first DCI is a subset or a complete set of {cell 1, cell 2, cell 3, cell 4}. The co-scheduled cell combinations in the first cell group are shown in Table 3.

The DCI format for scheduling the cell combinations is the DCI format 0_X or the DCI format 1_X, the DCI format 0_X is used to schedule the PUSCH, and the DCI format 1_X is used to schedule the PDSCH. In one example, a maximum number of data channels co-schedulable by the DCI format 0_X is 3, and the maximum number of data channels co-schedulable by the DCI format 1_X is 3.

The method for calculating the required quantities of bits in separately scheduling the cell 1, the cell 2, the cell 3, and the cell 4, that is, the first values, is described above, which is not repeated herein. Illustratively, using an example where the required quantities of bits in separately scheduling the cell 1, the cell 2, the cell 3, and the cell 4 are 6, 6, 7, and 8, the third value of the first cell combination is 6+6, that is, 12 bits; the third value of the second cell combination is 7+8, that is, 15 bits; the third value of the third cell combination is 6+7, that is, 13 bits; and the third value of the fourth cell combination is 6+6+7, that is, 20.

In 12, 15, 13, and 20, the largest third values is 20, and thus the first value is 20.

In summary, in the method according to the present disclosure, the first quantity of bits is determined based on the third values corresponding to all cell combinations scheduled by first DCI. Compared with the first determining method, the determined quantity of bits occupied by the FDRA indication field is less.

A fourth method for determining the first quantity of bits occupied by the FDRA indication field

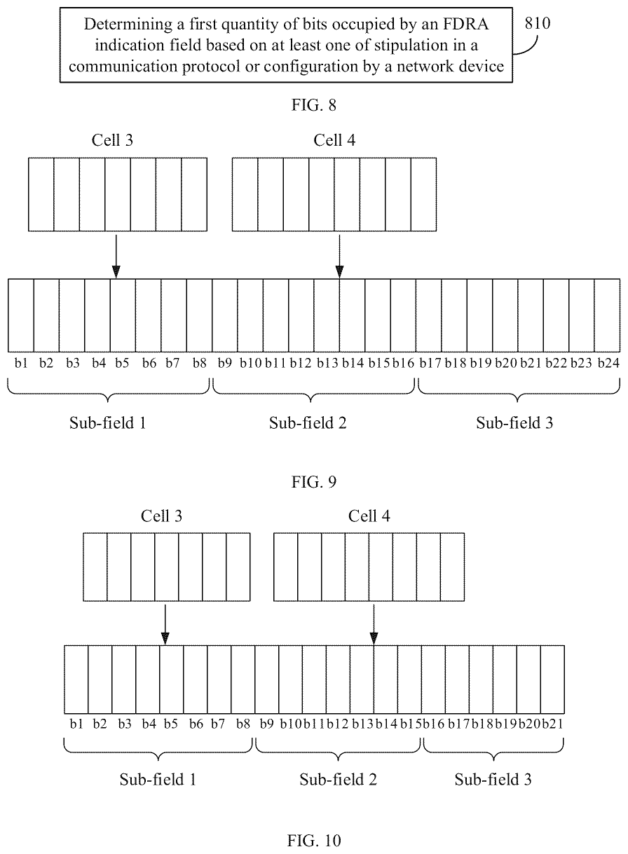

FIG. 8 is a flowchart of a method for receiving DCI according to some embodiments of the present disclosure. The method is applicable to a terminal device, and includes the following processes.

In S810, a first quantity of bits occupied by an FDRA indication field is determined based on at least one of stipulation in a communication protocol or configuration by a network device. In the embodiments, the first quantity of bits is determined based on at least one of:
the stipulation in the communication protocol; or
the configuration by the network device.

Illustratively, the network device configures that the first quantity of bits occupied by the FDRA indication field is 20.

In summary, in the method according to the present disclosure, the first quantity of bits is determined based on at least one of the stipulation in the communication protocol or configuration by the network device, which is more controllable.

### A First Method for Interpreting the Frequency Domain Resource Information Corresponding to N Data Channels by the FDRA Indication Field

FIG. 9 is a flowchart of a method for receiving DCI according to some embodiments of the present disclosure. In some embodiments, the FDRA indication field includes Nmax FDRA sub-fields. A quantity of bits occupied by each of the Nmax FDRA sub-fields is a second value. The second value indicates a quantity of bits occupied by each cell in the FDRA indication field, and the frequency domain resource information corresponding to the N data channels is indicated by N FDRA sub-fields in the Nmax FDRA sub-fields.

The terminal device determines the frequency domain resource information corresponding to the N data channels based on the N FDRA sub-fields in the Nmax FDRA sub-fields. The N FDRA sub-fields are N most or least significant sub-fields in the Nmax FDRA sub-fields. In some embodiments, the terminal device determines the N most or least significant sub-fields from the Nmax FDRA sub-fields, and determines frequency domain resource information corresponding to an i^{th} data channel based on an i^{th} FDRA sub-field in the N FDRA sub-fields. i is an integer not greater than N.

The N data channels arranged in a first order are in one-to-one correspondence with N most significant FDRA sub-fields in the Nmax FDRA sub-fields; or the N data channels arranged in a first order are in one-to-one correspondence with N least significant FDRA sub-fields in the Nmax FDRA sub-fields. The N most significant FDRA sub-fields are first N FDRA sub-fields in a descending order of significance, and the N least significant FDRA sub-fields are first N FDRA sub-fields in an ascending order of significance.

The first order is a descending order of cell indices, or an ascending order of cell indices, or an order of cells configured for a first cell combination, or a descending order of first values corresponding to N cells, or an ascending order of first values corresponding to N cells. The N cells are in one-to-one correspondence with the N data channels, and the first cell combination is a combination of the N cells.

In some embodiments, the first order is a combined order of the above order. For example, the first values are arranged in a descending order, and then the cell indices are arranged in an ascending order in a case where the first values of at least two data channels are the same, which is not limited in the present disclosure as long as that the arranging methods on the network device and the terminal device are the same.

Illustratively, the embodiments are illustrated using an example where the required quantities of bits in separately scheduling the cell 1, the cell 2, the cell 3, and the cell 4 are 6, 6, 7, and 8, and the second value is 8.

The first quantity of bits occupied by the FDRA indication field is 8*3, that is, 24 bits, and the FDRA indication field includes three FDRA sub-fields, that is, the sub-field 1, the sub-field 2, and the sub-field 3. The quantity of bits occupied by each sub-field is 8, that is, the sub-field 1 {b1 to b8}, the sub-field 2 {b9 to b16}, and the sub-field 3 {b17 to b24}.

In a case where the DCI format 0_X or the DCI format 1_X schedules the cell combination 2, that is, the cell 3 and the cel 4, using an example where the first order is an ascending order of cell indices, the data channels corresponding to the two cells arranged in the first order are in one-to-one correspondence with two most significant FDRA sub-fields in the three FDRA sub-fields. That is, the bits corresponding to the cell 3 are mapped to the sub-field 1, the bits corresponding to the cell 4 are mapped to the sub-field 2, and the sub-field 3 is a predetermined value or reserved.

In some embodiments, the seven bits corresponding to the cell 3 are mapped to first 7 bits (b1 to b7) or last 7 bits (b2 to b8) of the sub-field 1, and the remaining 1 bit of the sub-field 1 is set as a predetermined value or is reserved.

In summary, in the method according to the present disclosure, the frequency domain resource information corresponding to the N data channels is indicated by N FDRA sub-fields in the Nmax FDRA sub-fields, and the quantity of bits occupied by each of the FDRA sub-fields is the second value, such that the mapping method of the bits corresponding to the N data channels is determined, and the methos is simple and easy.

### A Second Method for Interpreting the Frequency Domain Resource Information Corresponding to N Data Channels by the FDRA Indication Field

FIG. 10 is a flowchart of a method for receiving DCI according to some embodiments of the present disclosure. In some embodiments, the FDRA indication field includes Nmax FDRA sub-fields. a quantity of bits of the Nmax FDRA sub-fields are in one-to-one correspondence with Nmax largest first values in first values corresponding to M cells based on a second order, and the frequency domain resource information corresponding to the N data channels is indicated by N FDRA sub-fields in the Nmax FDRA sub-fields.

The Nmax largest first values are first Nmax largest first values in a descending order in the first values corresponding to the M cells.

For example, Nmax is 3, the required quantities of bits in separately scheduling the cell 1, the cell 2, the cell 3, and the cell 4 are 6, 7, 7, and 7, and the three largest first values are 7, 7, and 7; or

Nmax is 3, the required quantities of bits in separately scheduling the cell 1, the cell 2, the cell 3, and the cell 4 are 5, 6, 7, and 8, and the three largest first values are 6, 7, and 8.

The second order is a descending order of first values corresponding to N cells, or an ascending order of first values corresponding to N cells, or an order of cells configured for a first cell combination.

The N data channels are in one-to-one correspondence with the N cells, the first cell combination is a combination of the N cells, and the order of cells configured for the first cell combination are configured by the network device based on an ascending order or descending order of the first values corresponding to cells in the cell combination.

The terminal device determines the frequency domain resource information corresponding to the N data channels based on the N FDRA sub-fields in the Nmax FDRA sub-fields, and determines frequency domain resource information corresponding to an i^{th} data channel based on an i^{th} FDRA sub-field in the N FDRA sub-fields. i is an integer not greater than N.

In some embodiments, the N data channels arranged in a second order are in one-to-one correspondence with N most significant FDRA sub-fields in the Nmax FDRA sub-fields. The N most significant FDRA sub-fields are first N FDRA sub-fields in a descending order of significance. For example, the Nmax FDRA sub-fields are ordered based on the first values in a descending order of significance, and the N data channels arranged based on the first values in a descending order of significance are in one-to-one correspondence with the N most significant FDRA sub-fields in the Nmax FDRA sub-fields.

In some embodiments, the N data channels arranged in a second order are in one-to-one correspondence with N least significant FDRA sub-fields in the Nmax FDRA sub-fields. For example, the Nmax FDRA sub-fields are arranged based on an ascending order of the first values, and the N data channels arranged based on an ascending order the first values are in one-to-one correspondence with the N least significant FDRA sub-fields in the Nmax FDRA sub-fields. It should be noted that the first value of the i^{th} data channel is not necessarily equal to the quantity of bits occupied by the i^{th} FDRA sub-field. In general, the first value of the i^{th} data channel is less than or equal to the quantity of bits occupied by the i^{th} FDRA sub-field.

In some embodiments, the second order is a combined order of different order. For example, the first values are arranged in a descending order, and then the cell indices are arranged in an ascending order in a case where the first values of at least two data channels are the same, which is not limited in the present disclosure as long as that the arranging methods on the network device and the terminal device are the same.

Illustratively, the embodiments are illustrated using an example where the required quantities of bits in separately scheduling the cell 1, the cell 2, the cell 3, and the cell 4 are 6, 6, 7, and 8, and the first quantity of bits occupied by the FDRA indication field is 8+7+6, that is, 21 bits.

The FDRA indication field includes three FDRA sub-fields, that is, the sub-field 1, the sub-field 2, and the sub-field 3. The quantities of bits occupied by the sub-fields are as follows, the sub-field 1 {b1 to b8}, that is, 8 bits, the sub-field 2 {b9 to b15}, that is, 7 bits, and the sub-field 3 {b16 to b21}, that is, 6 bits.

In a case where the DCI format 0_X or the DCI format 1_X schedules the cell combination 2, that is, the cell 3 and the cel 4, the second order is a descending order of first values, and the N data channels arranged in the second order are in one-to-one correspondence with N most significant FDRA sub-fields in the Nmax FDRA sub-fields. That is, 8 bits corresponding to the cell 4 are mapped to the sub-field 1, 7 bits corresponding to the cell 3 are mapped to the sub-field 2, and the sub-field 3 is a predetermined value or reserved.

In summary, in the method according to the present disclosure, the quantities of bits occupied by the FDRA sub-fields are in one-to-one correspondence with N first values in the first values corresponding to the M cells based on a second order, such that the method is applicable to various scenarios of different quantities of bits occupied by the FDRA sub-fields. The methos is simple and easy, and can save the quantities of bits required for the FDRA indication field.

### A Third Method for Interpreting the Frequency Domain Resource Information Corresponding to N Data Channels by the FDRA Indication Field

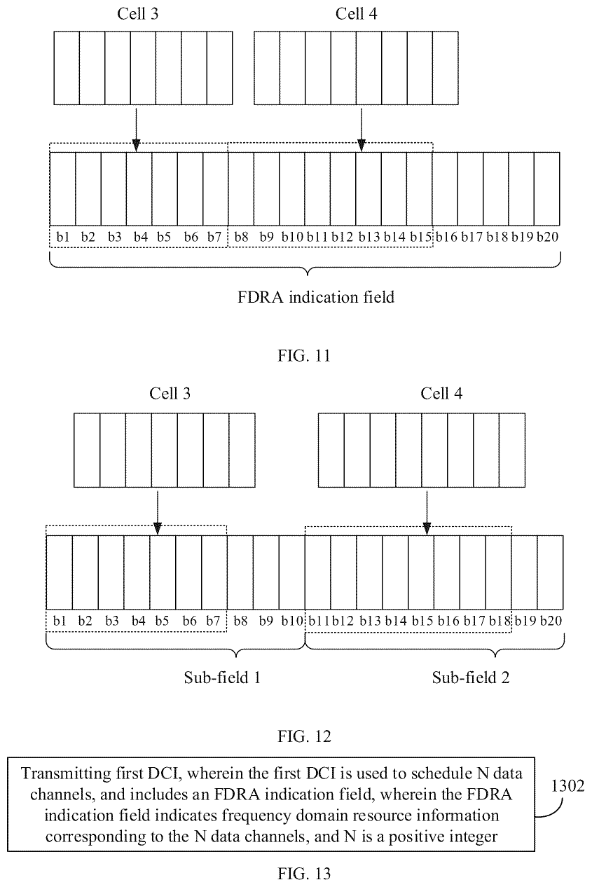

FIG. 11 is a flowchart of a method for receiving DCI according to some embodiments of the present disclosure. In some embodiments, the FDRA indication field occupies a first quantity of bits, and a quantity of bits required for FDRA of a first cell combination scheduled by the first DCI is a second quantity of bits. Bits of the second quantity are a subset of bits of the first quantity. The second quantity of bits is less than or equal to the first quantity of bits. The N data channel are in one-to-one correspondence with the N cells, and the first cell combination is a combination of the N cells.

The terminal device determines the frequency domain resource information corresponding to the N data channels based on the second quantity of bits in the FDRA indication field.

In some embodiments, the bits of the second quantity occupy most significant bits of the second quantity in the bits of the first quantity or least significant bits of the second quantity in the bits of the first quantity based on a third order. The third order is a descending order of cell indices, or an ascending order of cell indices, or a descending order of first values corresponding to N cells, or an ascending order of first values corresponding to N cells, or an order of cells configured for the first cell combination.

The order of cells configured for the first cell combination are configured by the network device based on an ascending order or descending order of the first values corresponding to cells in the cell combination.

Illustratively, the third order is a combined order of the above order. For example, the first values are arranged in a descending order, and then the cell indices are arranged in an ascending order in a case where the first values of at least two data channels are the same, which is not limited in the present disclosure as long as that the arranging methods on the network device and the terminal device are the same.

Illustratively, the embodiments are illustrated using an example where the required quantities of bits in separately scheduling the cell 1, the cell 2, the cell 3, and the cell 4 are 6, 6, 7, and 8, and the first quantity of bits occupied by the FDRA indication field is 20.

In a case where the DCI format 0_X or the DCI format 1_X schedules the cell combination 2, that is, the cell 3 and the cel 4, 7+8, that is, 15 bits are required. That is, the second quantity of bits is 15 bits. In some embodiments, the terminal determines the scheduled first cell combination based on another indication field in the first DCI, for example, a separate cell combination indication field; or determines the scheduled first cell combination by interpreting another indication field in the first DCI, for example, a time domain resource assignment (TDRA) indication field.

In a case where the third order is an ascending order of cell indices, 15 bits corresponding to the cell 3 and the cell 4 are mapped to 15 most/least significant bits occupied by the FDRA indication field. 7 bits corresponding to the cell 3 are first 7 bits in the 15 most/least significant bits occupied by the FDRA indication field, 8 bits corresponding to the cell 4 are last 8 bits in the 15 most/least significant bits occupied by the FDRA indication field, and the remaining 20-15, that is, 5 bits are a predetermined value or reserved. The predetermined value is 0, 1, or the like.

In summary, in the method according to the present disclosure, the FDRA indication field occupies the first quantity of bits, the quantity of bits required for FDRA of the first cell combination scheduled by the first DCI is the second quantity of bits, and bits of the second quantity occupy most significant bits of the second quantity in the bits of the first quantity or least significant bits of the second quantity in the bits of the first quantity based on the third order, such that the mapping is performed based on the quantity of bits required for each cell combination, and the applicable range of the method is wider.

### A Fourth Method for Interpreting the Frequency Domain Resource Information Corresponding to N Data Channels by the FDRA Indication Field

FIG. 12 is a flowchart of a method for receiving DCI according to some embodiments of the present disclosure. In some embodiments, the FDRA indication field includes N FDRA sub-fields. A quantity of bits occupied by each of the N FDRA sub-fields is determined based on a first average value, and the frequency domain resource information corresponding to the N data channels is indicated by the N FDRA sub-fields.

The quantity of bits occupied by each of the N FDRA sub-fields is the first average value or a rounded value of the first average value.

The first average value is a value acquired by dividing the first quantity of bits by N, and the rounded value includes at least one of a rounded-up value, a rounded-down value, or a rounded-off value.

The N data channels arranged in a fourth order are in one-to-one correspondence with the N FDRA sub-fields.

The fourth order is a descending order of cell indices, or an ascending order of cell indices, or an order of cells configured for a first cell combination, or a descending order of first values corresponding to N cells, or an ascending order of first values corresponding to N cells. The N data channels are in one-to-one correspondence with the N cells, the first cell combination is a combination of the N cells, and each of the first values is a quantity of bits required for FDRA in a case where each of the N cells is separately scheduled.

In some embodiments, the fourth order is a combined order of the above order. For example, the first values are arranged in a descending order, and then the cell indices are arranged in an ascending order in a case where the first values of at least two data channels are the same, which is not limited in the present disclosure as long as that the arranging methods on the network device and the terminal device are the same.

The terminal device determines the frequency domain resource information corresponding to the N data channels based on the N FDRA sub-fields in the Nmax FDRA sub-fields, and determines frequency domain resource information corresponding to an i^{th} data channel based on an i^{th} FDRA sub-field in the N FDRA sub-fields. i is an integer not greater than N.

In some examples, the network device configures {cell 1, cell 2, cell 3, and cell 4} as the first cell group. For the first cell group, the cell combination scheduled by the first DCI is a subset or a complete set of {cell 1, cell 2, cell 3, cell 4}. The co-scheduled cell combinations in the first cell group are shown in Table 3.

The DCI format for scheduling the cell combinations is the DCI format 0_X or the DCI format 1_X, the DCI format 0_X is used to schedule the PUSCH, and the DCI format 1_X is used to schedule the PDSCH. In one example, a maximum number of data channels co-schedulable by the DCI format 0_X is 3, and the maximum number of data channels co-schedulable by the DCI format 1_X is 3.

The method for calculating the required quantities of bits in separately scheduling the cell 1, the cell 2, the cell 3, and the cell 4, that is, the first values, is described above, which is not repeated herein. Illustratively, the embodiments are illustrated using an example where the required quantities of bits in separately scheduling the cell 1, the cell 2, the cell 3, and the cell 4 are 6, 6, 7, and 8, and the first quantity of bits occupied the FDRA indication field is 20.

In a case where the DCI format 0_X or the DCI format 1_X schedules the cell combination 2, that is, the cell 3 and the cel 4, the first quantity of bits, that is, 20 bits are organized to two FDRA sub-fields: the sub-field 1 {b1 to b10} and the sub-field 2 {b11 to b20}. Each sub-field includes 10 bits and are mapped based on an ascending order of cell indices. 7 bits corresponding to the cell 3 are mapped to the sub-field 1, and 8 bits corresponding to the cell 4 are mapped to the sub-field 2.

In some embodiments, any one of the first, second, and fourth interpretations as described above is used.

In a case where a first value corresponding to a cell corresponding to a first FDRA sub-field is less than or equal to a quantity of bits occupied by the first FDRA sub-field, the first value of most or least significant bits in the first FDRA sub-field indicate FDRA information.

In a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate FDRA information, wherein x is a quantity of bits occupied by the second FDRA sub-field.

In a case where a first value corresponding to a cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x is a quantity of bits occupied by the second FDRA sub-field.

The N data channels are in one-to-one correspondence with the N cells, x represents a quantity of bits occupied by the second FDRA sub-field, and remaining bits are default values, for example, 0 or 1. The remaining bits are remaining bits acquired by subtracting x from the first quantity of bits.

Illustratively, the embodiments are illustrated using an example where the required quantities of bits in separately scheduling the cell 1, the cell 2, the cell 3, and the cell 4 are 6, 6, 7, and 8, and the first quantity of bits occupied by the FDRA indication field is 20.

In a case where the DCI format 0_X or the DCI format 1_X schedules the cell combination 2, that is, the cell 3 and the cel 4, the first quantity of bits, that is, 20 bits are organized to two FDRA sub-fields: the sub-field 1 {b1 to b10} and the sub-field 2 {b11 to b20}. Each sub-field includes 10 bits, and 7 bits corresponding to the cell 3 and 8 bits corresponding to the cell 4 are less than 10 bits. Thus, 7 most/least significant bits occupied by the sub-field 1 are used to indicate the FDRA information, and 8 most/least significant bits occupied by the sub-field 2 are used to indicate the FDRA information.

Illustratively, the embodiments are illustrated using an example where the required quantities of bits in separately scheduling the cell 3 and the cell 4 are 11 bits and 12 bits, and the first quantity of bits occupied by the FDRA indication field is 20.

In a case where the DCI format 0_X or the DCI format 1_X schedules the cell combination 2, that is, the cell 3 and the cel 4, the first quantity of bits, that is, 20 bits are organized to two FDRA sub-fields: the sub-field 1 {b1 to b10} and the sub-field 2 {b11 to b20}. Each sub-field includes 10 bits, and 11 bits corresponding to the cell 3 and 12 bits corresponding to the cell 4 are greater than 10 bits. Thus, bits occupied by the sub-field 1 are determined as 10 most/least significant bits in the 11 bits, and the remaining bit is a default value 0 and is used to indicate the FDRA information; bits occupied by the sub-field 2 are determined as 10 most/least significant bits in the 12 bits, and the remaining 2 bits are a default value 0 and are used to indicate the FDRA information.

In some embodiments, any one of above first, second, and fourth interpreting methods is used.

A second FDRA granularity corresponding to a cell corresponding to an FDRA sub-field is determined based on a first value corresponding to the cell corresponding to the FDRA sub-field, a quantity of bits occupied by the FDRA sub-field, and a first FDRA granularity corresponding to the cell corresponding to the FDRA sub-field. The N data channels are in one-to-one correspondence with the N cells.

In some embodiments, in a case where the first value corresponding to the cell corresponding to the FDRA sub-field is less than or equal to the quantity of bits occupied by the FDRA sub-field, the first FDRA granularity corresponding to the cell corresponding to the FDRA sub-field is reduced; and in a case where the first value corresponding to the cell corresponding to the FDRA sub-field is greater than the quantity of bits occupied by the FDRA sub-field, the first FDRA granularity corresponding to the cell corresponding to the FDRA sub-field is enlarged.

In some embodiments, in a case where the first value Y corresponding to the cell corresponding to the FDRA sub-field or the quantity of bits Y indicating the RBs occupied by the data channel in the first values is less than or equal to the quantity of bits X of the FDRA sub-field or the quantity of bits X indicating the RBs occupied by the data channel in the FDRA sub-field (that is, remaining bits after subtracting the bits indicating the frequency domain resource type, the hopping frequency indication information, and the like), the first FDRA granularity corresponding to the cell corresponding to the FDRA sub-field is processed, and the acquired second FDRA granularity is:

$$⌊ \frac{Y * the FDRA granularity before reduction}{X} ⌋ or ⌈ \frac{Y * the FDRA granularity before reduction}{X} ⌉ .$$

Alternatively, the acquired second FDRA granularity is a value determined based on the above value from the first set, for example, a value not less than or not greater than the above value in the first set. The first set is configured or predefined. In some embodiments, the set elements in the first set all are values related to powers of 2.

In some embodiments, in a case where the first value Y corresponding to the cell corresponding to the FDRA sub-field is greater than the quantity of bits X of the FDRA sub-field, the first FDRA granularity corresponding to the cell corresponding to the FDRA sub-field is processed, and the acquired second FDRA granularity is:

$$⌊ \frac{Y * the FDRA granularity after enlargement}{X} ⌋ or ⌈ \frac{Y * the FDRA granularity after enlargement}{X} ⌉ .$$

Alternatively, the acquired second FDRA granularity is a value determined based on the above value from the first set, for example, a value not less than or not greater than the above value in the first set. The first set is configured or predefined. In some embodiments, the set elements in the first set all are values related to powers of 2.

It should be noted that the above FDRA granularity before enlargement/before reduction is also referred to as the “first FDRA granularity”, and the above FDRA granularity after enlargement/after reduction is also referred to as the “second FDRA granularity”. However, due to rounding upwards and rounding downwards, the second FDRA granularity may be equal to the first FDRA granularity even if X and Y are different, which is not limited in the embodiments.

Illustratively, the embodiments are illustrated using an example where the required quantities of bits in separately scheduling the cell 1, the cell 2, the cell 3, and the cell 4 are 6, 6, 7, and 8, and the first quantity of bits occupied by the FDRA indication field is 20.

In a case where the DCI format 0_X or the DCI format 1_X schedules the cell combination 2, that is, the cell 3 and the cel 4, the first quantity of bits, that is, 20 bits are organized to two FDRA sub-fields: the sub-field 1 {b1 to b10} and the sub-field 2 {b11 to b20}. Each sub-field includes 10 bits. Assuming that the predefined first FDRA granularity corresponding to the cell 3 is that each bit corresponding to 10 RBs, which indicates that 80 RBs needs 8 bits, then in a case where the quantity of bits occupied by the sub-field 1 corresponding to the cell 3 is 10 bits, the first FDRA granularity corresponding to the cell 3 is reduced, and the FDRA is performed based on the case that each bit corresponding to 8 RBs, and 10 bits are used to indicate 10*8, that is 80 RBs, such that a finer indicating effect of the frequency domain resource is achieved.

In summary, in the method according to the present disclosure, the quantities of bits occupied by the N FDRA sub-fields are the first average value or the rounded value of the first average value. The first average value is a value acquired by dividing the first quantity of bits by N, and the frequency domain resource information corresponding to the N data channels is indicated by the N FDRA sub-fields, such that the quantity of bits occupied by the FDRA indication field is fully used.

In the method according to the present disclosure, in a case where the first value corresponding to the cell corresponding to the first FDRA sub-field is less than or equal to the quantity of bits occupied by the first FDRA sub-field, the first value of most or least significant bits in the first FDRA sub-field indicate the FDRA information;
in a case where the first value corresponding to the cell corresponding to the second FDRA sub-field is greater than the quantity of bits occupied by the second FDRA sub-field, the bits in the second FDRA sub-field are determined as x most or least significant bits in the first value of bits to indicate the FDRA information, wherein x is the quantity of bits occupied by the second FDRA sub-field; or
in a case where the first value corresponding to the cell corresponding to the first FDRA sub-field is less than or equal to the quantity of bits occupied by the first FDRA sub-field, the first value of most or least significant bits in the first FDRA sub-field indicate the FDRA information; and in a case where the first value corresponding to the cell corresponding to the second FDRA sub-field is greater than the quantity of bits occupied by the second FDRA sub-field, the bits in the second FDRA sub-field are determined as x most or least significant bits in the first value of bits to indicate the FDRA information. The above three methods are simpler and easier.

In the method according to the present disclosure, the second FDRA granularity corresponding to the cell corresponding to the FDRA sub-field is determined based on the first value corresponding to the cell corresponding to the FDRA sub-field and the quantity of bits occupied by the FDRA sub-field, such that the second FDRA granularity is optimized, or the scheduling limitation is reduced.

In above embodiments, the first method for determining the first quantity of bits occupied by the FDRA indication field may be combined with the first method and the second method for interpreting the frequency domain resource information corresponding to the N data channels by the FDRA indication field;
the second method for determining the first quantity of bits occupied by the FDRA indication field may be combined with the first method and the second method for interpreting the frequency domain resource information corresponding to the N data channels by the FDRA indication field;
the third method for determining the first quantity of bits occupied by the FDRA indication field may be combined with the first method, the second method, the third method, and the fourth method for interpreting the frequency domain resource information corresponding to the N data channels by the FDRA indication field;
the fourth method for determining the first quantity of bits occupied by the FDRA indication field may be combined with the first method, the second method, the third method, and the fourth method for interpreting the frequency domain resource information corresponding to the N data channels by the FDRA indication field;
the first method for interpreting the frequency domain resource information corresponding to the N data channels by the FDRA indication field may be combined with the first method and the second method for determining the first quantity of bits occupied by the FDRA indication field;
the second method for interpreting the frequency domain resource information corresponding to the N data channels by the FDRA indication field may be combined with the first method and the second method for determining the first quantity of bits occupied by the FDRA indication field;
the third method for interpreting the frequency domain resource information corresponding to the N data channels by the FDRA indication field may be combined with the first method, the second method, the third method, and the fourth method for determining the first quantity of bits occupied by the FDRA indication field; and
the fourth method for interpreting the frequency domain resource information corresponding to the N data channels by the FDRA indication field may be combined with the first method, the second method, the third method, and the fourth method for determining the first quantity of bits occupied by the FDRA indication field.

The combination approaches of various interpreting methods and various methods for determining the first quantity of bits are not limited in the present disclosure, and those skilled in the art may randomly combine and improve various interpreting methods and various methods for determining the first quantity of bits based on interpretations.

FIG. 13 is a flowchart of a method for receiving DCI according to some embodiments of the present disclosure. The method is applicable to a network device, and includes the following processes.

In S1302, first DCI is transmitted, wherein the first DCI is used to schedule N data channels, and includes an FDRA indication field, wherein the FDRA indication field indicates frequency domain resource information corresponding to the N data channels, and N is a positive integer.

The FDRA indication field indicates the frequency domain resource information of the N scheduled data channels, or indicates the frequency domain resource information for the data channels corresponding to N cells in a scheduled first cell combination. The scheduled first cell combination is a combination of the N cells. The first cell combination belongs to a first cell group. The N data channels are in one-to-one correspondence with the N cells. N is a positive integer

In some embodiments, N is equal to or greater than 1. In a case where N is greater than 1, the scheduling is also referred to as multi-cell co-scheduling.

In some embodiments, the FDRA indication field includes at least N FDRA sub-fields. The N FDRA sub-fields are in one-to-one correspondence with the N data channels, and an i^{th} FDRA indication sub-field indicates frequency domain resource information of an i^{th} data channel. i is an integer not greater than N.

In some embodiments, the FDRA indication field includes N bit sequences. The N bit sequences are in one-to-one correspondence with the N data channels, and an i^{th} bit sequence indicates frequency domain resource information of an i^{th} data channel. i is an integer not greater than N.

In some embodiments, the FDRA indication field includes one bit sequence. Part of bits in the bit sequences correspond to the N data channels. The part of bits are organized to N parts of bits, and the N parts of bits are in one-to-one correspondence with the N data channels.

In some embodiments, the N data channels are in at least one of the following cases.
The N data channels are all PDSCHs;
the N data channels are all PUSCHs; or
the N data channels include some PDSCHs and some PUSCHs.

In some embodiments, the N data channels further include sidelink data channels.

In some embodiments, the first cell group is configured by the network device to the terminal device, or is predefined by the protocol. In some embodiments, an arrangement order of the cells in the first cell group is also pre-configured by the network device to the terminal device, or is predefined by the protocol. In some embodiments, arrangement orders of the cells in various cell groups are also pre-configured by the network device to the terminal device, or is predefined by the protocol.

In summary, in the method according to the embodiments, the first DCI is transmitted, and is configured to schedule the N data channel. The first DCI includes the FDRA indication field, and the FDRA indication field indicates the frequency domain resource information corresponding to the N data channels, such that the terminal device determines the first quantity of bits occupied by the FDRA indication field.

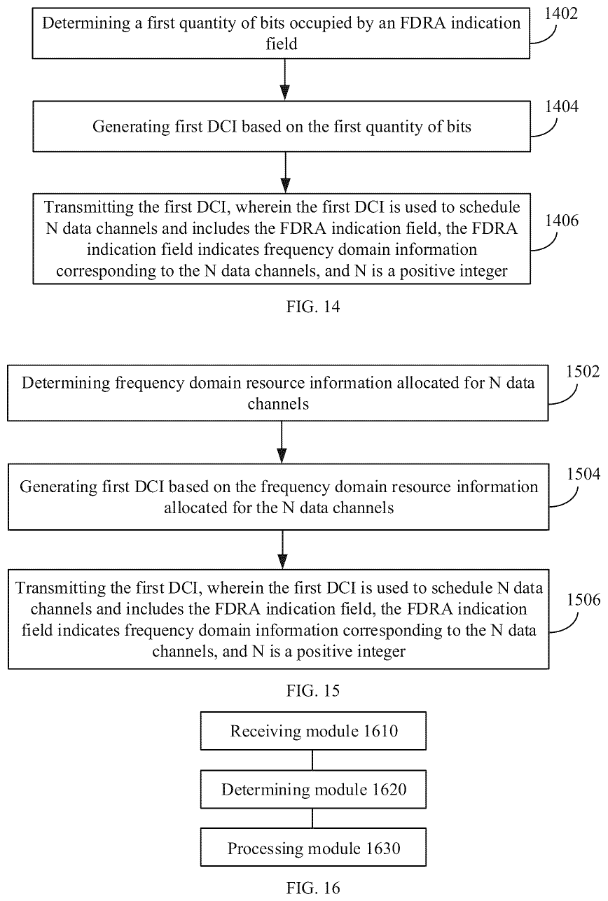

FIG. 14 is a flowchart of a method for receiving DCI according to some embodiments of the present disclosure. The method is applicable to a network device, and includes the following processes.

In S1402, a first quantity of bits occupied by an FDRA indication field is determined.

The first quantity of bits occupied by the FDRA indication field is determined based on at least one of:
a maximum number Nmax of data channels co-schedulable by the first DCI, wherein Nmax is a maximum value of N; or
a first value corresponding to each cell in a first cell group, wherein the first value is a quantity of bits required for FDRA in a case where each cell is separately scheduled.

In some embodiments, the first quantity of bits is determined based on first values corresponding to the M cells in the first cell group. In some embodiments, the first quantity of bits is determined based on Nmax largest first values in the first values corresponding to the M cells in the first cell group. In some embodiments, the first quantity of bits is determined based on first values corresponding to the N cells in the first cell combination. In some embodiments, the first quantity of bits is determined based on N largest first values in the first values corresponding to the M cells in the first cell group. In some embodiments, the arrangement order of the cells in the cell combination is also pre-configured by the network device to the terminal device, or is predefined by the protocol.

The N data channels are in one-to-one correspondence with the N cells, the N cells are a subset or a complete set of the first cell group, and the first cell group is a set of the M cells. M is greater than or equal to N, and N is a positive integer. The data channels co-schedulable by the first DCI mean the data channels that the first DCI allows to co-schedule, or the data channels that the first DCI can co-schedule, the data channels that the DCI format of the first DCI supports in co-scheduling, or the data channels that the DCI format of the first DCI allows to co-schedule.

Illustratively, assuming that the first cell is any cell in the M cells in the first cell group, then the first value of the first cell is determined based on at least one of:
1. a size of the activation BWP of the first cell, for example, the activation BWP includes a first number of RBs;
2. an FDRA type corresponding to the first cell, for example, the FDRA type 0 or the FDRA type 1;
3. a first FDRA granularity corresponding to the first cell, for example, the RBG includes a second number of RBs; or
4. a frequency-hopping related parameter corresponding to the first cell, for example, a frequency hopping offset list parameter frequencyHoppingOffsetLists.

In S1404, first DCI is generated based on the first quantity of bits.

The network device determines, configures, or generates the first DCI based on the first quantity of bits occupied by the FDRA indication field. the quantity of bits occupied by the FDRA indication field in the first DCI is the first quantity of bits.

In S1406, the first DCI is transmitted, wherein the first DCI is used to schedule N data channels and includes the FDRA indication field, the FDRA indication field indicates frequency domain information corresponding to the N data channels, and N is a positive integer.

In summary, in the method according to the present disclosure, the first quantity of bits occupied by the FDRA indication field is determined, the first DCI is generated based on the first quantity of bits and is transmitted to the terminal device, and the FDRA indication field indicates the frequency domain information corresponding to the N data channels, such that the terminal device determines the frequency domain resource information corresponding to the N data channels by one piece of DCI.

Based on the embodiments shown in FIG. 14, at least one of the following determining methods is used.

### A First Method for Determining the First Quantity of Bits Occupied by the FDRA Indication Field

In some embodiments, the first quantity of bits is determined based on the maximum number Nmax of data channels co-schedulable by first DCI and the second value. The second value indicates the quantity of bits occupied by each cell in the FDRA indication field.

The first quantity of bits is determined based on the maximum number Nmax of data channels co-schedulable by first DCI and the second value. In some embodiments, the first quantity of bits is a product of the maximum number Nmax of data channels co-schedulable by the first DCI and the second value.

In some embodiments, the second value includes at least one of:
a maximum value in M first values corresponding to M cells;
a minimum value in M first values corresponding to M cells;
an average value of M first values corresponding to M cells;
a median value of M first values corresponding to M cells;
a first value corresponding to a cell with a largest cell index in M cells; or
a first value corresponding to a cell with a smallest cell index in M cells;

A first cell group is a set of the M cells, N cells are in one-to-one correspondence with the N data channels, and the N cells are a subset or a complete set of the first cell group. M is greater than or equal to N.

In some embodiments, the second value is determined based on a first value corresponding to a second cell. The second cell is configured by the network device or predefined by the communication protocol.

In some embodiments, the second value is predefined by the communication protocol or is configured by the network device, and is greater than or equal to a maximum value in the first values corresponding to each cell in the M cells.

### A Second Method for Determining the First Quantity of Bits Occupied by the FDRA Indication Field

In some embodiments, the first quantity of bits is determined based on the Nmax largest first values in the first values corresponding to M cells. Nmax is a largest number of data channels co-schedulable by the first DCI.

The first quantity of bits is determined based on the Nmax largest first values in the first values corresponding to the M cells. In some embodiments, the first quantity of bits is a sum of the Nmax largest first values in the first values corresponding to the M cells.

The data channels co-schedulable by the first DCI mean the data channels that the first DCI allows to co-schedule, or the data channels that the first DCI can co-schedule, or the data channels that the DCI format of the first DCI supports in co-scheduling, or the data channels that the DCI format of the first DCI allows to co-schedule.

### A Third Method for Determining the First Quantity of Bits Occupied by the FDRA Indication Field

In some embodiments, the first quantity of bits is determined based on the third values corresponding to all cell combinations scheduled by first DCI, wherein the third value corresponding to each of the all cell combinations is a sum of first values corresponding to cells in the each of the all cell combinations.

The first quantity of bits is determined based on the third values corresponding to all cell combinations scheduled by the first DCI. The third value corresponding to each of the all cell combinations is the sum of the first values corresponding to the cells in the each of the all cell combinations, and the all cell combinations belong to the first cell group.

All cell combinations scheduled by the first DCI mean all cell combinations that the first DCI allows to schedule, or all cell combinations that the first DCI can schedule, or all cell combinations that the DCI format of the first DCI supports in co-scheduling, or all cell combinations that the DCI format of the first DCI allows to co-schedule. In one scheduling process, the first DCI only schedules one cell combination.

In some embodiments, the first quantity of bits is a maximum value in the third values corresponding to the all cell combinations scheduled by the first DCI. In some embodiments, the first quantity of bits is a minimum value in the third values corresponding to the all cell combinations scheduled by the first DCI. In some embodiments, the first quantity of bits is an average value of the third values corresponding to the all cell combinations scheduled by the first DCI. In some embodiments, the first quantity of bits is a third value corresponding to the first cell combination currently scheduled by the first DCI.

### A Fourth Method for Determining the First Quantity of Bits Occupied by the FDRA Indication Field

In the embodiments, the first quantity of bits is determined based on at least one of:
the stipulation in the communication protocol; or
the configuration by the network device.

Details of the methods for determining the first quantity of bits occupied by the FDRA indication field, reference may be made to the embodiments applicable to the terminal device, which is not repeated herein.

FIG. 15 is a flowchart of a method for receiving DCI according to some embodiments of the present disclosure. The method is applicable to a network device, and includes the following processes.

In S1502, frequency domain resource information allocated for N data channels is determined.

In some embodiments, N is equal to or greater than 1. In a case where N is greater than 1, the scheduling is also referred to as multi-cell co-scheduling.

In some embodiments, the FDRA indication field includes at least N FDRA sub-fields. The N FDRA sub-fields are in one-to-one correspondence with the N data channels, and an i^{th} FDRA indication sub-field indicates frequency domain resource information of an i^{th} data channel. i is an integer not greater than N.

In some embodiments, the FDRA indication field includes N bit sequences. The N bit sequences are in one-to-one correspondence with the N data channels, and all or part bits in an i^{th} bit sequence are generated based on frequency domain resource information of an i^{th} data channel. i is an integer not greater than N.

In some embodiments, the FDRA indication field includes one bit sequence. Part of bits in the bit sequences correspond to the N data channels. The part of bits are organized to N parts of bits, and the N parts of bits are in one-to-one correspondence with the N data channels.

In S1504, first DCI is generated based on the frequency domain resource information allocated for the N data channels.

The network device determines, configures, or generates the first DCI based on the frequency domain resource information allocated for the N data channels. The quantity of bits occupied by the FDRA indication field in the first DCI is the first quantity of bits.

In S1506, the first DCI is transmitted, wherein the first DCI is used to schedule N data channels and includes the FDRA indication field, the FDRA indication field indicates frequency domain information corresponding to the N data channels, and N is a positive integer.

In summary, in the method according to the present disclosure, the frequency domain resource information allocated for the N data channels is determined. The first DCI is generated based on the frequency domain resource information allocated for the N data channels, is transmitted to the terminal device, is used to schedule N data channels, and includes the FDRA indication field. The FDRA indication field indicates frequency domain information corresponding to the N data channels. As such, the terminal device determines the frequency domain resource information corresponding to the N data channels by one piece of DCI.

Based on the embodiments shown in FIG. 15, at least one of the following generating methods is used.

### A First Method for Generating the Frequency Domain Resource Information Corresponding to N Data Channels by the FDRA Indication Field

In some embodiments, the FDRA indication field generated by the network device includes Nmax FDRA sub-fields, the frequency domain resource information corresponding to the N data channels is indicated by N FDRA sub-fields in the Nmax FDRA sub-fields, and the quantity of bits occupied by each of the Nmax FDRA sub-fields is the second value.

The N data channels arranged in a first order are in one-to-one correspondence with N most significant FDRA sub-fields in the Nmax FDRA sub-fields; or the N data channels arranged in a first order are in one-to-one correspondence with N least significant FDRA sub-fields in the Nmax FDRA sub-fields. The remaining FDRA sub-field other than the N FDRA sub-fields is a predetermined value or is reserved.

The first order is a descending order of cell indices, or an ascending order of cell indices, or an order of cells configured for a first cell combination, or a descending order of first values corresponding to N cells, or an ascending order of first values corresponding to N cells. The first cell combination is a combination of the N cells.

### A Second Method for Generating the Frequency Domain Resource Information Corresponding to N Data Channels by the FDRA Indication Field

In some embodiments, the FDRA indication field generated by the network device includes Nmax FDRA sub-fields, the frequency domain resource information corresponding to the N data channels is indicated by N FDRA sub-fields in the Nmax FDRA sub-fields, and the quantities of bits occupied by the Nmax FDRA sub-fields are in one-to-one correspondence with Nmax largest first values in first values corresponding to M cells based on the second order.

The second order is a descending order of first values corresponding to N cells, or an ascending order of first values corresponding to N cells, or an order of cells configured for a first cell combination.

The N data channels are in one-to-one correspondence with the N cells, the first cell combination is a combination of the N cells, and the order of cells configured for the first cell combination are configured by the network device based on an ascending order or descending order of the first values corresponding to cells in the cell combination.

The N data channels arranged in the second order are in one-to-one correspondence with N most significant FDRA sub-fields in the Nmax FDRA sub-fields; or

the N data channels arranged in the second order are in one-to-one correspondence with N least significant FDRA sub-fields in the Nmax FDRA sub-fields.

### A Third Method for Generating the Frequency Domain Resource Information Corresponding to N Data Channels by the FDRA Indication Field

In some embodiments, the FDRA indication field generated by the network device occupies the first quantity of bits, and the quantity of bits required for FDRA of the first cell combination scheduled by the first DCI is the second quantity of bits.

In some embodiments, the bits of the second quantity occupy most/least significant bits of the second quantity in the bits of the first quantity based on a third order. The third order is a descending order of cell indices, or an ascending order of cell indices, or a descending order of first values corresponding to N cells, or an ascending order of first values corresponding to N cells, or an order of cells configured for the first cell combination. The remaining bits other than bits of the second quantity in bits of the first quantity are of a predetermined value or are reserved.

The order of cells configured for the first cell combination are configured by the network device based on an ascending order or descending order of the first values corresponding to cells in the cell combination.

### A Fourth Method for Generating the Frequency Domain Resource Information Corresponding to N Data Channels by the FDRA Indication Field

In some embodiments, the FDRA indication field generated by the network device includes N FDRA sub-fields. A quantity of bits occupied by each of the N FDRA sub-fields is determined based on a first average value, and the frequency domain resource information corresponding to the N data channels is indicated by the N FDRA sub-fields.

The quantity of bits occupied by each of the N FDRA sub-fields is the first average value or a rounded value of the first average value.

The first average value is a value acquired by dividing the first quantity of bits by N, and the rounded value includes at least one of a rounded-up value, a rounded-down value, or a rounded-off value.

The N data channels arranged in a fourth order are in one-to-one correspondence with the N FDRA sub-fields.

The fourth order is a descending order of cell indices, or an ascending order of cell indices, or an order of cells configured for a first cell combination, or a descending order of first values corresponding to N cells, or an ascending order of first values corresponding to N cells. The N data channels are in one-to-one correspondence with the N cells, and the first cell combination is a combination of the N cells.

The order of cells configured for the first cell combination are configured by the network device based on an ascending order or descending order of the first values corresponding to cells in the cell combination.

In some embodiments, in a case where a first value corresponding to a data channel/cell corresponding to a first FDRA sub-field is less than or equal to a quantity of bits occupied by the first FDRA sub-field, the first value of most or least significant bits in the first FDRA sub-field indicate FDRA information;

in a case where a first value corresponding to a data channel/cell corresponding to a second FDRA sub-field is greater than a quantity of bits occupied by the second FDRA sub-field, bits in the second FDRA sub-field are determined as x most or least significant bits in the first value of bits to indicate FDRA information, wherein x represents a quantity of bits occupied by the second FDRA sub-field; or

in a case where a first value corresponding to a data channel/cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a data channel/cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x represents a quantity of bits occupied by the second FDRA sub-field.

The N data channels are in one-to-one correspondence with the N cells, x is a quantity of bits occupied by the second FDRA sub-field, and remaining bits are default values, for example, 0 or 1. The remaining bits are remaining bits acquired by subtracting x from the first quantity of bits.

In some embodiments, a second FDRA granularity corresponding to a data channel/cell corresponding to an FDRA sub-field is determined based on a first value corresponding to the data channel/cell corresponding to the FDRA sub-field and a quantity of bits occupied by the FDRA sub-field.

In some embodiments, in a case where the first value corresponding to the data channel/cell corresponding to the first FDRA sub-field is less than or equal to the quantity of bits occupied by the FDRA sub-field, the first FDRA granularity corresponding to the data channel/cell corresponding to the first FDRA sub-field is enlarged.

In some embodiments, in a case where the first value corresponding to the data channel/cell corresponding to the second FDRA sub-field is greater than the quantity of bits occupied by the FDRA sub-field, the first FDRA granularity corresponding to the data channel/cell corresponding to the second FDRA sub-field is reduced.

The first FDRA sub-field is any of a plurality of FDRA sub-fields, and the second FDRA sub-field is any of a plurality of FDRA sub-fields.

Details of the methods for generating the frequency domain resource information corresponding to N data channels by the FDRA indication field, reference may be made to the methods for determining the frequency domain resource information corresponding to N data channels by the FDRA indication field applicable to the terminal device, which is not repeated herein.

It should be noted that various methods for determining the first quantity of bits and various interpreting methods of by the FDRA indication field may be randomly combined based on interpreting of those skilled in the art. The embodiments of the present disclosure are only part of the combination embodiments, and those skilled in the art may derive more embodiments based on above description.

FIG. 16 is a block diagram of an apparatus for receiving downlink control information according to some embodiments of the present disclosure. The apparatus includes at least part of a receiving module 1610, a determining module 1620, or a processing module 1630. The function of the receiving module 1610 is achieved by the receiver in the terminal device, and the functions of the determining module 1620 and the processing module 1630 are achieved by the processor in the terminal device.

The receiving module 1610 is configured to receive first DCI, wherein the first DCI is used to schedule N data channels, and includes an FDRA indication field, wherein the FDRA indication field indicates frequency domain resource information corresponding to the N data channels, and N is a positive integer.

In some embodiments, the determining module 1620 is configured to determine a first quantity of bits occupied by the FDRA indication field based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where the each of the at least one cell is separately scheduled.

In some embodiments, the first quantity of bits is determined based on the maximum number Nmax of data channels co-schedulable by the first DCI and a second value, wherein the second value indicates a quantity of bits occupied by the each of the at least one cell in the FDRA indication field, and
the second value is determined based on the first value corresponding to the each of the at least one cell, is predefined by a communication protocol, or is configured by a network device.

In some embodiments, the first quantity of bits is a product of the maximum number Nmax of data channels co-schedulable by the first DCI and the second value.

In some embodiments, the first cell group is a set of M cells, and the first quantity of bits is determined based on Nmax largest first values in first values corresponding to the M cells, wherein M is an integer greater than or equal to N.

In some embodiments, the first quantity of bits is a sum of the Nmax largest first values in the first values corresponding to the M cells.

In some embodiments, the determining module 1620 is configured to determine the first quantity of bits based on third values corresponding to all cell combinations scheduled by the first DCI, wherein the third value corresponding to each of the all cell combinations is a sum of first values corresponding to cells in the each of the all cell combinations, and the all cell combinations belong to the first cell group.

In some embodiments, the first quantity of bits is a maximum value in the third values corresponding to the all cell combinations scheduled by the first DCI.

In some embodiments, the FDRA indication field includes Nmax FDRA sub-fields, and the frequency domain resource information corresponding to the N data channels is indicated by N FDRA sub-fields in the Nmax FDRA sub-fields.

In some embodiments, the apparatus further includes the processing module 1630, configured to cause the N data channels arranged in a first order to be in one-to-one correspondence with N most significant FDRA sub-fields in the Nmax FDRA sub-fields; or
cause the N data channels arranged in a first order to be in one-to-one correspondence with N least significant FDRA sub-fields in the Nmax FDRA sub-fields;
wherein the first order is an ascending order of cell indices, or a descending order of cell indices, or an order of cells configured for a first cell combination, or a descending order of first values corresponding to N cells, or an ascending order of first values corresponding to N cells, the N cells are in one-to-one correspondence with the N data channels, and the first cell combination is a combination of the N cells.

In some embodiments, the FDRA indication field includes Nmax FDRA sub-fields, wherein a quantity of bits occupied by each of the Nmax FDRA sub-fields is a second value,
wherein the second value indicates a quantity of bits occupied by each cell in the FDRA indication field, and the frequency domain resource information corresponding to the N data channels is indicated by N FDRA sub-fields in the Nmax FDRA sub-fields.

In some embodiments, the FDRA indication field includes Nmax FDRA sub-fields, wherein quantities of bits occupied by the Nmax FDRA sub-fields are in one-to-one correspondence with Nmax largest first values in first values corresponding to M cells based on a second order, and
the frequency domain resource information corresponding to the N data channels is indicated by N FDRA sub-fields in the Nmax FDRA sub-fields.

In some embodiments, the second order is a descending order of first values corresponding to N cells, or an ascending order of first values corresponding to N cells, or an order of cells configured for a first cell combination,
the N data channels are in one-to-one correspondence with the N cells, and the first cell combination is a combination of the N cells.

In some embodiments, a quantity of bits required for FDRA of a first cell combination scheduled by the first DCI is a second quantity of bits, wherein bits of the second quantity are a subset of bits of the first quantity.

In some embodiments, the processing module 1630 is configured to cause the bits of the second quantity to occupy most significant bits of the second quantity in the bits of the first quantity or least significant bits of the second quantity in the bits of the first quantity based on a third order.

In some embodiments, the third order is a descending order of cell indices, or an ascending order of cell indices, or a descending order of first values corresponding to N cells, or an ascending order of first values corresponding to N cells, or an order of cells configured for the first cell combination,
wherein each of the first values is a quantity of bits required for FDRA in a case where each of the N cells is separately scheduled, the N data channels are in one-to-one correspondence with the N cells, and the first cell combination is a combination of the N cells.

In some embodiments, the FDRA indication field includes N FDRA sub-fields, wherein a quantity of bits occupied by each of the N FDRA sub-fields is determined based on a first average value, and the frequency domain resource information corresponding to the N data channels is indicated by the N FDRA sub-fields.

In some embodiments, the quantity of bits occupied by each of the N FDRA sub-fields is the first average value or a rounded value of the first average value,
wherein the first average value is a value acquired by dividing the first quantity of bits by N, and the rounded value includes at least one of a rounded-up value, a rounded-down value, or a rounded-off value.

In some embodiments, the processing module 1630 is configured to cause the N data channels arranged in a fourth order to be in one-to-one correspondence with the N FDRA sub-fields, wherein
the fourth order is a descending order of cell indices, or an ascending order of cell indices, or an order of cells configured for a first cell combination, or a descending order of first values corresponding to N cells, or an ascending order of first values corresponding to N cells; and
the N data channels are in one-to-one correspondence with the N cells, the first cell combination is a combination of the N cells, and each of the first values is a quantity of bits required for FDRA in a case where each of the N cells is separately scheduled.

In some embodiments, in a case where a first value corresponding to a cell corresponding to a first FDRA sub-field is less than or equal to a quantity of bits occupied by the first FDRA sub-field, the first value of most or least significant bits in the first FDRA sub-field indicate FDRA information;
in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate FDRA information, wherein x represents a quantity of bits occupied by of the second FDRA sub-field; or
in a case where a first value corresponding to a cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x is a quantity of bits occupied by the second FDRA sub-field;
wherein the first value is a quantity of bits required for FDRA in a case where each cell is separately scheduled.

In some embodiments, the processing module 1630 is configured to determine a second FDRA granularity corresponding to a cell corresponding to an FDRA sub-field based on a first value corresponding to the cell corresponding to the FDRA sub-field and a quantity of bits occupied by the FDRA sub-field, wherein the first value is a quantity of bits required for FDRA in a case where each cell is separately scheduled.

In some embodiments, the FDRA indication field includes Nmax FDRA sub-fields, and
the frequency domain resource information corresponding to the N data channels is indicated by N FDRA sub-fields in the Nmax FDRA sub-fields,
wherein Nmax is a maximum number of data channels co-schedulable by the first DCI, and is a maximum value of N.

In some embodiments, the processing module 1630 is configured to cause the N data channels arranged in a first order to be in one-to-one correspondence with N most significant FDRA sub-fields in the Nmax FDRA sub-fields; or
cause the N data channels arranged in a first order to be in one-to-one correspondence with N least significant FDRA sub-fields in the Nmax FDRA sub-fields;
wherein the first order is a descending order of cell indices, or an ascending order of cell indices, or an order of cells configured for a first cell combination, or a descending order of first values corresponding to N cells, or an ascending order of first values corresponding to N cells, wherein each of the first values is a quantity of bits required for FDRA in a case where each of the N cells is separately scheduled,
wherein the N data channels are in one-to-one correspondence with the N cells, and the first cell combination is a combination of the N cells.

In some embodiments, a quantity of bits occupied by each of the Nmax FDRA sub-fields is a second value, wherein the second value indicates a quantity of bits occupied by each cell in the FDRA indication field, and is determined based on a first value corresponding to each of N cells, is predefined by a communication protocol, or is configured by a network device, the N data channels are in one-to-one correspondence with the N cells, and the first value is a quantity of bits required for FDRA in a case where each of the N cells is separately scheduled.

In some embodiments, quantities of bits occupied by the Nmax FDRA sub-fields are in one-to-one correspondence with Nmax largest first values in first values corresponding to M cells based on a second order,
wherein the N data channels are in one-to-one correspondence with N cells, a first cell group is a set of M cells, the N cells are a subset or a complete set of the first cell group, M is greater than or equal to N, and each of the first values is a quantity of bits required for FDRA in a case where each of the N cells is separately scheduled.

In some embodiments, the second order is a descending order of first values corresponding to the N cells, or an ascending order of first values corresponding to the N cells, or an order of cells configured for a first cell combination, wherein the first cell combination is a combination of the N cells.

In some embodiments, the FDRA indication field occupies a first quantity of bits, and a quantity of bits required for FDRA of a first cell combination scheduled by the first DCI is a second quantity of bits, wherein bits of the second quantity are a subset of bits of the first quantity, the N data channels are in one-to-one correspondence with N cells, wherein the first cell combination is a combination of N cells.

In some embodiments, the processing module 1630 is configured to cause the bits of the second quantity to occupy most significant bits of the second quantity in the bits of the first quantity or least significant bits of the second quantity in the bits of the first quantity based on a third order.

In some embodiments, the third order is a descending order of cell indices, or an ascending order of cell indices, or a descending order of first values corresponding to N cells, or an ascending order of first values corresponding to N cells, or an order of cells configured for a first cell combination,
wherein each of the first values is a quantity of bits required for FDRA in a case where each of the N cells is separately scheduled.

In some embodiments, the FDRA indication field includes N FDRA sub-fields, wherein a quantity of bits occupied by each of the N FDRA sub-fields is determined based on a first average value, and the frequency domain resource information corresponding to the N data channels is indicated by the N FDRA sub-fields.

In some embodiments, the quantity of bits occupied by each of the N FDRA sub-fields is the first average value or a rounded value of the first average value,
wherein the first average value is a value acquired by dividing a first quantity of bits by N, the rounded value includes at least one of a rounded-up value, a rounded-down value, or a rounded-off value, and the first quantity of bits is a quantity of bits occupied by the FDRA indication field.

In some embodiments, the N data channels arranged in a fourth order are in one-to-one correspondence with the N FDRA sub-fields, wherein
the fourth order is a descending order of cell indices, or an ascending order of cell indices, or an order of cells configured for a first cell combination, or a descending order of first values corresponding to N cells, or an ascending order of first values corresponding to N cells; and
the N data channels are in one-to-one correspondence with the N cells, the first cell combination is a combination of the N cells, and each of the first values is a quantity of bits required for FDRA in a case where each of the N cells is separately scheduled.

In some embodiments, in a case where a first value corresponding to a cell corresponding to a first FDRA sub-field is less than or equal to a quantity of bits occupied by the first FDRA sub-field, the first value of most or least significant bits in the first FDRA sub-field indicate FDRA information;
in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate FDRA information, wherein x represents a quantity of bits occupied by the second FDRA sub-field; or
in a case where a first value corresponding to a cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x is a quantity of bits occupied by the second FDRA sub-field;
wherein the first value is a quantity of bits required for FDRA in a case where each cell is separately scheduled.

In some embodiments, the processing module 1630 is configured to determine a second FDRA granularity corresponding to a cell corresponding to an FDRA sub-field based on a first value corresponding to the cell corresponding to the FDRA sub-field and a quantity of bits occupied by the FDRA sub-field, wherein the first value is a quantity of bits required for FDRA in a case where each cell is separately scheduled.

In some embodiments, the determining module 1620 is configured to determine a first quantity of bits occupied by the FDRA indication field based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where each of the at least one cell is separately scheduled;
wherein the N data channels are in one-to-one correspondence with N cells, and the N cells are a subset or a complete set of the first cell group.

In some embodiments, the determining module 1620 is configured to determine a first quantity of bits based on a maximum number Nmax of data channels co-schedulable by the first DCI and a second value, and
the first quantity of bits is a quantity of bits occupied by the FDRA indication field, wherein the second value indicates a quantity of bits occupied by each cell in the FDRA indication field, and the N data channels are in one-to-one correspondence with N cells.

In some embodiments, the first quantity of bits is a product of the maximum number Nmax of data channels co-schedulable by the first DCI and the second value.

In some embodiments, the determining module 1620 is configured to determine the first quantity of bits based on Nmax largest first values in first values corresponding to M cells, and is a quantity of bits occupied by the FDRA indication field, wherein each of the first values is a quantity of bits required for FDRA in a case where each of the M cells is separately scheduled,
the N data channels are in one-to-one correspondence with N cells, a first cell group is a set of the M cells, and the N cells are a subset or a complete set of the first cell group.

In some embodiments, the first quantity of bits is a sum of the Nmax largest first values in the first values corresponding to the M cells.

In some embodiments, the determining module 1620 is configured to determine a first quantity of bits based on third values corresponding to all cell combinations scheduled by the first DCI, wherein the third value corresponding to each of the all cell combinations is a sum of first values corresponding to cells in the each of the all cell combinations; and
the first quantity of bits is a quantity of bits occupied by the FDRA indication field, wherein each of the first values is a quantity of bits required for FDRA in a case where each of the cells is separately scheduled.

In some embodiments, the first quantity of bits is a maximum value in the third values corresponding to the all cell combinations scheduled by the first DCI.

In some embodiments, a first cell is any of the at least one cell, and a first value corresponding to the first cell is determined based on at least one of:
a size of an activation BWP of the first cell;
an FDRA type corresponding to the first cell;
a first FDRA granularity corresponding to the first cell; or
a frequency-hopping related parameter corresponding to the first cell.

In some embodiments, the second value includes at least one of:
a maximum value in M first values corresponding to M cells;
a minimum value in M first values corresponding to M cells;
an average value of M first values corresponding to M cells;
a median value of M first values corresponding to M cells;
a first value corresponding to a cell with a largest cell index in M cells; or
a first value corresponding to a cell with a smallest cell index in M cells;
wherein a first cell group is a set of the M cells, N cells are in one-to-one correspondence with the N data channels, and the N cells are a subset or a complete set of the first cell group, wherein M is greater than or equal to N.

In some embodiments, the second value is determined based on a first value corresponding to a second cell, wherein the second cell is configured by a network device or predefined by a communication protocol.

In some embodiments, an order of cells configured for the first cell combination is configured by a network device based on an ascending order or descending order of first values corresponding to cells in the first cell combination.

In some embodiments, the N data channels all are PDSCHs; the N data channels all are PUSCHs; or the N data channels include part of PDSCHs and part of PUSCHs.

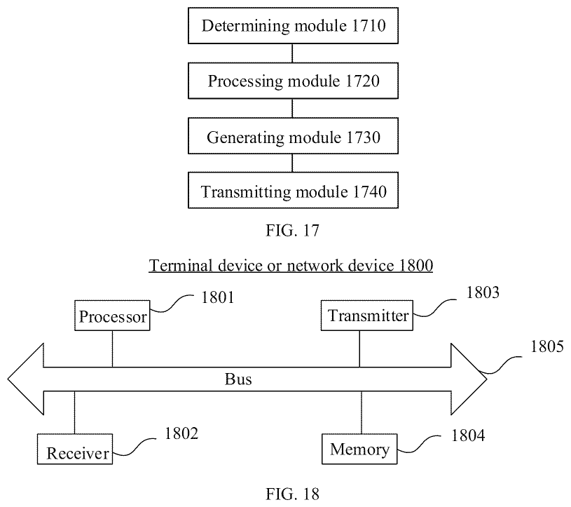

FIG. 17 is a block diagram of an apparatus for transmitting downlink control information according to some embodiments of the present disclosure. The apparatus includes at least part of a determining module 1710, a processing module 1720, a generating module 1730, or a transmitting module 1740. The functions of the determining module 1710, the processing module 1720, and the generating module 1730 are achieved by the processor in the network device, and the function of the transmitting module 1740 is achieved by the transmitter in the network device.

The transmitting module 1740 is configured to transmit first DCI, wherein the first DCI is used to schedule N data channels, and includes an FDRA indication field, wherein the FDRA indication field indicates frequency domain resource information corresponding to the N data channels, and N is a positive integer.

In some embodiments, the apparatus further includes the determining module 1710, configured to determine a first quantity of bits occupied by the FDRA indication field based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where the each of the at least one cell is separately scheduled.

In some embodiments, the first quantity of bits is determined based on the maximum number Nmax of data channels co-schedulable by the first DCI and a second value, wherein the second value indicates a quantity of bits occupied by the each of the at least one cell in the FDRA indication field, and
the second value is determined based on the first value corresponding to the each of the at least one cell, is predefined by a communication protocol, or is configured by a network device.

In some embodiments, the first quantity of bits is a product of the maximum number Nmax of data channels co-schedulable by the first DCI and the second value.

In some embodiments, the first cell group is a set of M cells, and the first quantity of bits is determined based on Nmax largest first values in first values corresponding to the M cells, wherein M is an integer greater than or equal to N.

In some embodiments, the first quantity of bits is a sum of the Nmax largest first values in the first values corresponding to the M cells.

In some embodiments, the determining module 1710 is configured to determine the first quantity of bits based on third values corresponding to all cell combinations scheduled by the first DCI, wherein the third value corresponding to each of the all cell combinations is a sum of first values corresponding to cells in the each of the all cell combinations, and the all cell combinations belong to the first cell group.

In some embodiments, the first quantity of bits is a maximum value in the third values corresponding to the all cell combinations scheduled by the first DCI.

In some embodiments, the FDRA indication field includes Nmax FDRA sub-fields, and
the frequency domain resource information corresponding to the N data channels is indicated by N FDRA sub-fields in the Nmax FDRA sub-fields.

In some embodiments, the apparatus further includes the processing module 1720, configured to cause the N data channels arranged in a first order to be in one-to-one correspondence with N most significant FDRA sub-fields in the Nmax FDRA sub-fields; or
cause the N data channels arranged in a first order to be in one-to-one correspondence with N least significant FDRA sub-fields in the Nmax FDRA sub-fields;
wherein the first order is a descending order of cell indices, or an ascending order of cell indices, or an order of cells configured for a first cell combination, or a descending order of first values corresponding to N cells, or an ascending order of first values corresponding to N cells, the N cells are in one-to-one correspondence with the N data channels, and the first cell combination is a combination of the N cells.

In some embodiments, the FDRA indication field includes Nmax FDRA sub-fields, wherein a quantity of bits occupied by each of the Nmax FDRA sub-fields is a second value,
wherein the second value indicates a quantity of bits occupied by each cell in the FDRA indication field, and the frequency domain resource information corresponding to the N data channels is indicated by N FDRA sub-fields in the Nmax FDRA sub-fields.

In some embodiments, the FDRA indication field includes Nmax FDRA sub-fields, wherein quantities of bits occupied by the Nmax FDRA sub-fields are in one-to-one correspondence with Nmax largest first values in first values corresponding to M cells based on a second order, and
the frequency domain resource information corresponding to the N data channels is indicated by N FDRA sub-fields in the Nmax FDRA sub-fields.

In some embodiments, the second order is a descending order of first values corresponding to N cells, or an ascending order of first values corresponding to N cells, or an order of cells configured for a first cell combination,
the N data channels are in one-to-one correspondence with the N cells, and the first cell combination is a combination of the N cells.

In some embodiments, a quantity of bits required for FDRA of a first cell combination scheduled by the first DCI is a second quantity of bits, wherein bits of the second quantity are a subset of the bits of the first quantity.

In some embodiments, the processing module 1720 is configured to cause the bits of the second quantity to occupy most significant bits of the second quantity in the bits of the first quantity or occupy least significant bits of the second quantity in the bits of the first quantity based on a third order.

In some embodiments, the third order is a descending order of cell indices, or an ascending order of cell indices, or a descending order of first values corresponding to N cells, or an ascending order of first values corresponding to N cells, or an order of cells configured for the first cell combination,
wherein each of the first values is a quantity of bits required for FDRA in a case where each of the N cells is separately scheduled, the N data channels are in one-to-one correspondence with the N cells, and the first cell combination is a combination of the N cells.

In some embodiments, the FDRA indication field includes N FDRA sub-fields, wherein a quantity of bits occupied by each of the N FDRA sub-fields is determined based on a first average value, and the frequency domain resource information corresponding to the N data channels is indicated by the N FDRA sub-fields.

In some embodiments, the quantity of bits occupied by each of the N FDRA sub-fields is the first average value or a rounded value of the first average value,
wherein the first average value is a value acquired by dividing the first quantity of bits by N, and the rounded value includes at least one of a rounded-up value, a rounded-down value, or a rounded-off value.

In some embodiments, the processing module 1720 is configured to cause the N data channels arranged in a fourth order to be in one-to-one correspondence with the N FDRA sub-fields, wherein
the fourth order is a descending order of cell indices, or an ascending order of cell indices, or an order of cells configured for a first cell combination, or a descending order of first values corresponding to N cells, or an ascending order of first values corresponding to N cells; and
the N data channels are in one-to-one correspondence with the N cells, the first cell combination is a combination of the N cells, and each of the first values is a quantity of bits required for FDRA in a case where each of the N cells is separately scheduled.

In some embodiments, in a case where a first value corresponding to a cell corresponding to a first FDRA sub-field is less than or equal to a quantity of bits occupied by the first FDRA sub-field, the first value of most or least significant bits in the first FDRA sub-field indicate FDRA information;
in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate FDRA information, wherein x is a quantity of bits occupied by the second FDRA sub-field; or
in a case where a first value corresponding to a cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x represents a quantity of bits occupied by the second FDRA sub-field;
wherein the first value is a quantity of bits required for FDRA in a case where each cell is separately scheduled.

In some embodiments, the processing module 1720 is configured to determine a second FDRA granularity corresponding to a cell corresponding to an FDRA sub-field based on a first value corresponding to the cell corresponding to the FDRA sub-field and a quantity of bits occupied by the FDRA sub-field, wherein the first value is a quantity of bits required for FDRA in a case where each cell is separately scheduled.

In some embodiments, the FDRA indication field includes Nmax FDRA sub-fields, and
the frequency domain resource information corresponding to the N data channels is indicated by N FDRA sub-fields in the Nmax FDRA sub-fields,
wherein Nmax is a maximum number of data channels co-schedulable by the first DCI, and is a maximum value of N.

In some embodiments, the processing module 1720 is configured to cause the N data channels arranged in a first order to be in one-to-one correspondence with N most significant FDRA sub-fields in the Nmax FDRA sub-fields; or
cause the N data channels arranged in a first order to be in one-to-one correspondence with N least significant FDRA sub-fields in the Nmax FDRA sub-fields;
wherein the first order is a descending order of cell indices, or an ascending order of cell indices, or an order of cells configured for a first cell combination, or a descending order of first values corresponding to N cells, or an ascending order of first values corresponding to N cells, wherein each of the first values is a quantity of bits required for FDRA in a case where each of the N cells is separately scheduled,
wherein the N data channels are in one-to-one correspondence with the N cells, and the first cell combination is a combination of the N cells.

In some embodiments, a quantity of bits occupied by each of the Nmax FDRA sub-fields is a second value, wherein the second value indicates a quantity of bits occupied by each cell in the FDRA indication field, and is determined based on a first value corresponding to each of N cells, is predefined by a communication protocol, or is configured by a network device, the N data channels are in one-to-one correspondence with the N cells, and the first value is a quantity of bits required for FDRA in a case where each of the N cells is separately scheduled.

In some embodiments, quantities of bits occupied by the Nmax FDRA sub-fields are in one-to-one correspondence with Nmax largest first values in first values corresponding to M cells based on a second order,
wherein the N data channels are in one-to-one correspondence with N cells, a first cell group is a set of M cells, the N cells are a subset or a complete set of the first cell group, M is greater than or equal to N, and each of the first values is a quantity of bits required for FDRA in a case where each of the N cells is separately scheduled.

In some embodiments, the second order is a descending order of first values corresponding to the N cells, or an ascending order of first values corresponding to the N cells, or an order of cells configured for a first cell combination, wherein the first cell combination is a combination of the N cells.

In some embodiments, the FDRA indication field occupies bits of the first quantity, and a quantity of bits required for FDRA of a first cell combination scheduled by the first DCI is a second quantity of bits, wherein bits of second quantity are a subset of the bits of the first quantity,
the N data channels are in one-to-one correspondence with N cells, wherein the first cell combination is a combination of N cells.

In some embodiments, the processing module 1720 is configured to cause bits of the second quantity to occupy most significant bits of the second quantity in the bits of the first quantity or occupy least significant bits of the second quantity in the bits of the first quantity based on a third order.

In some embodiments, the third order is a descending order of cell indices, or an ascending order of cell indices, or a descending order of first values corresponding to N cells, or an ascending order of first values corresponding to N cells, or an order of cells configured for a first cell combination,
wherein each of the first values is a quantity of bits required for FDRA in a case where each of the N cells is separately scheduled.

In some embodiments, the FDRA indication field includes N FDRA sub-fields, wherein a quantity of bits occupied by each of the N FDRA sub-fields is determined based on a first average value, and the frequency domain resource information corresponding to the N data channels is indicated by the N FDRA sub-fields.

In some embodiments, the quantity of bits occupied by each of the N FDRA sub-fields is the first average value or a rounded value of the first average value,
wherein the first average value is a value acquired by dividing a first quantity of bits by N, the rounded value includes at least one of a rounded-up value, a rounded-down value, or a rounded-off value, and the first quantity of bits is a quantity of bits occupied by the FDRA indication field.

In some embodiments, the N data channels arranged in a fourth order are in one-to-one correspondence with the N FDRA sub-fields, wherein
the fourth order is a descending order of cell indices, or an ascending order of cell indices, or an order of cells configured for a first cell combination, or a descending order of first values corresponding to N cells, or an ascending order of first values corresponding to N cells; and
the N data channels are in one-to-one correspondence with the N cells, the first cell combination is a combination of the N cells, and each of the first values is a quantity of bits required for FDRA in a case where each of the N cells is separately scheduled.

In some embodiments, in a case where a first value corresponding to a cell corresponding to a first FDRA sub-field is less than or equal to a quantity of bits occupied by the first FDRA sub-field, the first value of most or least significant bits in the first FDRA sub-field indicate FDRA information;
in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate FDRA information, wherein x represents a quantity of bits occupied by the second FDRA sub-field; or
in a case where a first value corresponding to a cell corresponding to a first FDRA sub-field is less than or equal to a quantity of bits occupied by the first FDRA sub-field, the first value of most or least significant bits in the first FDRA sub-field indicate FDRA information; and in a case where a first value corresponding to a cell corresponding to a second FDRA sub-field is greater than a quantity of bits occupied by the second FDRA sub-field, bits in the second FDRA sub-field are determined as x most or least significant bits in the first value of bits to indicate the FDRA information, wherein x represents a quantity of bits occupied by the second FDRA sub-field;
wherein the first value is a quantity of bits required for FDRA in a case where each cell is separately scheduled.

In some embodiments, the processing module 1720 is configured to determine a second FDRA granularity corresponding to a cell corresponding to an FDRA sub-field based on a first value corresponding to the cell corresponding to the FDRA sub-field and a quantity of bits occupied by the FDRA sub-field, wherein the first value is a quantity of bits required for FDRA in a case where each cell is separately scheduled.

In some embodiments, the determining module 1710 is configured to determine a first quantity of bits occupied by the FDRA indication field based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where each of the at least one cell is separately scheduled;
wherein the N data channels are in one-to-one correspondence with N cells, and the N cells are a subset or a complete set of the first cell group.

In some embodiments, the determining module 1710 is configured to determine a first quantity of bits based on a maximum number Nmax of data channels co-schedulable by the first DCI and a second value, and
the first value is a quantity of bits occupied by the FDRA indication field, wherein the second value indicates a quantity of bits occupied by each cell in the FDRA indication field, and the N data channels are in one-to-one correspondence with N cells.

In some embodiments, the first quantity of bits is a product of the maximum number Nmax of data channels co-schedulable by the first DCI and the second value.

In some embodiments, the first quantity of bits is determined based on Nmax largest first values in first values corresponding to M cells, and is a quantity of bits occupied by the FDRA indication field, wherein each of the first values is a quantity of bits required for FDRA in a case where each of the M cells is separately scheduled,
the N data channels are in one-to-one correspondence with N cells, a first cell group is a set of the M cells, and the N cells are a subset or a complete set of the first cell group.

In some embodiments, the first quantity of bits is a sum of the Nmax largest first values in the first values corresponding to the M cells.

In some embodiments, the first quantity of bits is determined based on third values corresponding to all cell combinations scheduled by the first DCI, wherein the third value corresponding to each of the all cell combinations is a sum of first values corresponding to cells in the each of the all cell combinations; and
the first quantity of bits is a quantity of bits occupied by the FDRA indication field, wherein each of the first values is a quantity of bits required for FDRA in a case where each of the cells is separately scheduled.

In some embodiments, the first quantity of bits is a maximum value in the third values corresponding to the all cell combinations scheduled by the first DCI.

In some embodiments, a first cell is any of the at least one cell, and a first value corresponding to the first cell is determined based on at least one of:
a size of an activation BWP of the first cell;
an FDRA type corresponding to the first cell;
a first FDRA granularity corresponding to the first cell; or
a frequency-hopping related parameter corresponding to the first cell.

In some embodiments, the second value includes at least one of:
a maximum value in M first values corresponding to M cells;
a minimum value in M first values corresponding to M cells;
an average value of M first values corresponding to M cells;
a median value of M first values corresponding to M cells;
a first value corresponding to a cell with a largest cell index in M cells; or
a first value corresponding to a cell with a smallest cell index in M cells;
wherein a first cell group is a set of the M cells, N cells are in one-to-one correspondence with the N data channels, and the N cells are a subset or a complete set of the first cell group, wherein M is greater than or equal to N.

In some embodiments, the second value is determined based on a first value corresponding to a second cell, wherein the second cell is configured by a network device or predefined by a communication protocol.

In some embodiments, an order of cells configured for the first cell combination is configured by a network device based on an ascending order or descending order of first values corresponding to cells in the first cell combination.

In some embodiments, the N data channels all are PDSCHs; the N data channels all are PUSCHs; or the N data channels include part of PDSCHs and part of PUSCHs.

In some embodiments, the apparatus further includes the generating module 1730, configured to generate the first DCI based on the first quantity of bits and/or the frequency domain resource information allocated for the N data channels.

It should be noted that the apparatus according to the above embodiments is only illustrated by the division of the above functional modules. In practical applications, the above functions can be assigned by different functional modules according to needs. That is, the internal structure of the apparatus is divided into different functional modules to achieve all or part of the functions described above.

Detailed operation methods of various modules of the apparatus according to the embodiments are detailed in the method embodiments, and thus are not detailed herein.

FIG. 18 is a schematic structural diagram of a terminal device or a network device 1800 according to some embodiments of the present disclosure. The terminal device or the network device 1800 includes: a processor 1801, a receiver 1802, a transmitter 1803, a memory 1804, and a bus 1805.

The processor 1801 includes one or more processing cores, and achieves various functional applications and information processing by running software programs and modules. In some embodiments, the processor 1801 is configured to achieve functions and processes of the above determining module 1620, the processing module 1630, the determining module 1710, the processing module 1720, and the generating module 1730.

The receiver 1802 and the transmitter 1803 are practiced as a communication assembly. The communication assembly is a communication chip. In some embodiments, the receiver 1802 is configured to achieve functions and processes of the above receiving module 1610, and the transmitter 1803 is configured to achieve functions and processes of the above transmitting module 1740.

The memory 1804 is connected to the processor 1801 over the bus 1805.

The memory 1804 is configured to store one or more instructions, and the processor 1801 is configured to load and execute the one or more instructions to perform various processes in the above method embodiments.

In addition, the memory 1804 is practiced by any type of volatile or non-volatile storage device or combinations thereof. The volatile or non-volatile storage device includes but is not limited to a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some embodiments, the receiver 1802 receives signals/data separately, the processor 1801 controls the receiver 1802 to receive signals/data, the processor 1801 requests the receiver 1802 to receive signals/data, or, the processor 1801 cooperates with the receiver 1802 to receive signals or data.

In some embodiments, the transmitter 1803 transmits signals/data separately, the processor 1801 controls the transmitter 1803 to transmit signals or data, the processor 1801 requests the transmitter 1803 to transmit signals/data, or, the processor 1801 cooperates with the transmitter 1803 to transmit signals or data.

Some embodiments of the present disclosure further provide a computer-readable storage medium storing one or more programs. The computer-readable storage medium stores at least one instruction, at least one program, a code set, or an instruction set, wherein the at least one instruction, the at least one program, the code set, or the instruction set, when loaded and executed or run by a processor, causes the terminal device or the network device to perform the method for receiving or transmitting DCI in the above method embodiments.

Some embodiments of the present disclosure further provide a computer program product or a computer program. The computer program product or the computer program, when running on a processor, causes the terminal device or the network device to perform the method for receiving or transmitting DCI in the above method embodiments.

It should be understood by those of ordinary skill in the art that all or part of processes in the above embodiments are implemented by the hardware or the related hardware instructed by the program. The program is stored in a computer-readable storage medium, and the storage medium is an ROM, a disk or an optical disc.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for receiving downlink control information (DCI), applicable to a terminal device, the method comprising:
receiving first DCI, wherein the first DCI is used to schedule N data channels and comprises a frequency domain resource assignment (FDRA) indication field, wherein the FDRA indication field indicates frequency domain resource information corresponding to the N data channels, and N is a positive integer.

2. The method according to claim 1, wherein a first quantity of bits occupied by the FDRA indication field is determined based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where the each of the at least one cell is separately scheduled.

3. The method according to claim 2, wherein the first quantity of bits is determined based on the maximum number Nmax of data channels co-schedulable by the first DCI and a second value, wherein the second value indicates a quantity of bits occupied by each of the at least one cell in the FDRA indication field, and is determined based on the first value corresponding to the each of the at least one cell, or is predefined by a communication protocol or configured by a network device.

4. The method according to claim 2, wherein the first cell group is a set of M cells, and the first quantity of bits is determined based on Nmax largest first values in first values corresponding to the M cells, wherein M is an integer greater than or equal to N.

5. The method according to claim 2, wherein the FDRA indication field comprises N FDRA sub-fields, wherein a quantity of bits occupied by each of the N FDRA sub-fields is determined based on a first average value, and the frequency domain resource information corresponding to the N data channels is indicated by the N FDRA sub-fields.

6. The method according to claim 5, wherein the quantity of bits occupied by each of the N FDRA sub-fields is the first average value or a rounded value of the first average value, wherein the first average value is a value acquired by dividing the first quantity of bits by N, and the rounded value includes at least one of a rounded-up value, a rounded-down value, or a rounded-off value.

7. The method according to claim 5, wherein the N data channels arranged in a fourth order are in one-to-one correspondence with the N FDRA sub-fields, wherein:
the fourth order is a descending order of cell indices, or an ascending order of cell indices, or an order of cells configured for a first cell combination, or a descending order of first values corresponding to N cells, or an ascending order of first values corresponding to N cells; and
the N data channels are in one-to-one correspondence with the N cells, the first cell combination is a combination of the N cells, and each of the first values is a quantity of bits required for FDRA in a case where each of the N cells is separately scheduled.

8. A terminal device, comprising:
a processor, a transceiver connected to the processor, and a memory storing one or more executable instructions of the processor;
wherein the transceiver is configured to execute the one or more executable instructions to cause the terminal device to:
receive first downlink control information (DCI), wherein the first DCI is used to schedule N data channels and comprises a frequency domain resource assignment (FDRA) indication field, wherein the FDRA indication field indicates frequency domain resource information corresponding to the N data channels, and N is a positive integer.

9. The terminal device according to claim 8, wherein a first quantity of bits occupied by the FDRA indication field is determined based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where the each of the at least one cell is separately scheduled.

10. The terminal device according to claim 9, wherein the first quantity of bits is determined based on the maximum number Nmax of data channels co-schedulable by the first DCI and a second value, wherein the second value indicates a quantity of bits occupied by each of the at least one cell in the FDRA indication field, and is determined based on the first value corresponding to the each of the at least one cell, or is predefined by a communication protocol or configured by a network device.

11. The terminal device according to claim 9, wherein the first cell group is a set of M cells, and the first quantity of bits is determined based on Nmax largest first values in first values corresponding to the M cells, wherein M is an integer greater than or equal to N.

12. The terminal device according to claim 9, wherein the FDRA indication field comprises N FDRA sub-fields, wherein a quantity of bits occupied by each of the N FDRA sub-fields is determined based on a first average value, and the frequency domain resource information corresponding to the N data channels is indicated by the N FDRA sub-fields.

13. The terminal device according to claim 12, wherein the quantity of bits occupied by each of the N FDRA sub-fields is the first average value or a rounded value of the first average value, wherein the first average value is a value acquired by dividing the first quantity of bits by N, and the rounded value includes at least one of a rounded-up value, a rounded-down value, or a rounded-off value.

14. The terminal device according to claim 12, wherein the N data channels arranged in a fourth order are in one-to-one correspondence with the N FDRA sub-fields;
wherein the fourth order is a descending order of cell indices, or an ascending order of cell indices, or an order of cells configured for a first cell combination, or a descending order of first values corresponding to N cells, or an ascending order of first values corresponding to N cells; and
wherein the N data channels are in one-to-one correspondence with the N cells, the first cell combination is a combination of the N cells, and each of the first values is a quantity of bits required for FDRA in a case where each of the N cells is separately scheduled.

15. A network device, comprising:
a processor, a transceiver connected to the processor, and a memory storing one or more executable instructions of the processor;
wherein the transceiver is configured to execute the one or more executable instructions to cause the network device to:
transmit first downlink control information (DCI), wherein the first DCI is used to schedule N data channels, and comprises a frequency domain resource assignment (FDRA) indication field, wherein the FDRA indication field indicates frequency domain resource information corresponding to the N data channels, and N is a positive integer.

16. The network device according to claim 15, wherein a first quantity of bits occupied by the FDRA indication field is determined based on at least one of:
a maximum number Nmax of data channels co-schedulable by the first DCI, wherein Nmax is a maximum value of N; or
a first value corresponding to each of at least one cell in a first cell group, wherein the first value is a quantity of bits required for FDRA in a case where the each of the at least one cell is separately scheduled.

17. The network device according to claim 16, wherein the first quantity of bits is determined based on the maximum number Nmax of data channels co-schedulable by the first DCI and a second value, wherein the second value indicates a quantity of bits occupied by the each of the at least one cell in the FDRA indication field, and is determined based on the first value corresponding to the each of the at least one cell, is predefined by a communication protocol, or is configured by the network device.

18. The network device according to claim 16, wherein the first cell group is a set of M cells, and the first quantity of bits is determined based on Nmax largest first values in first values corresponding to the M cells, wherein M is an integer greater than or equal to N.

19. The network device according to claim 16, wherein the FDRA indication field comprises N FDRA sub-fields, wherein a quantity of bits occupied by each of the N FDRA sub-fields is determined based on a first average value, and the frequency domain resource information corresponding to the N data channels is indicated by the N FDRA sub-fields.

20. The network device according to claim 19, wherein the N data channels arranged in a fourth order are in one-to-one correspondence with the N FDRA sub-fields;
wherein the fourth order is a descending order of cell indices, or an ascending order of cell indices, or an order of cells configured for a first cell combination, or a descending order of first values corresponding to N cells, or an ascending order of first values corresponding to N cells; and
wherein the N data channels are in one-to-one correspondence with the N cells, the first cell combination is a combination of the N cells, and each of the first values is a quantity of bits required for FDRA in a case where each of the N cells is separately scheduled.
